(19) United States
(12) Patent Application Publication
(10) Pub. No.: US 2025/0070854 A1
(43) Pub. Date: Feb. 27, 2025

(54) MULTI-TRAFFIC RELAY TRANSMISSION

(71) Applicant: Samsung Electronics Co., Ltd., Suwon-si (KR)

(72) Inventors: Yue Qi, Plano, TX (US); Rubayet Shafin, Frisco, TX (US); Boon Loong Ng, Plano, TX (US); Abhishek Sehgal, Frisco, TX (US); Peshal Nayak, Plano, TX (US); Vishnu Vardhan Ratnam, Plano, TX (US); Elliot Jen, Taipei City (TW)

(21) Appl. No.: 18/791,124

(22) Filed: Jul. 31, 2024

Related U.S. Application Data
(60) Provisional application No. 63/533,806, filed on Aug. 21, 2023.
(60) Provisional application No. 63/540,294, filed on Sep. 25, 2023.
(60) Provisional application No. 63/544,282, filed on Oct. 16, 2023.
(60) Provisional application No. 63/546,703, filed on Oct. 31, 2023.

(51) Int. Cl. H04B 7/155; H04W 28/02; H04W 74/0816

(52) U.S. Cl. CPC H04B 7/155; H04W 28/0215; H04W 74/0816

(57) ABSTRACT

Method and apparatus for multi-traffic relay transmission. A method of wireless communication performed by a wireless device, the method comprising: receiving, from a source node, an indication of relay capabilities for multi-traffic transmission; receiving a message from the source node indicating that the message is for relay operations; and relaying the message to a destination node.

### CROSS-REFERENCE TO RELATED APPLICATIONS AND CLAIM OF PRIORITY

This application claims priority under 35 U.S.C. § 119(e) to U.S. Provisional Patent Application No. 63/533,806 filed on Aug. 21, 2023; U.S. Provisional Patent Application No. 63/540,294 filed on Sep. 25, 2023; U.S. Provisional Patent Application No. 63/544,282 filed on Oct. 16, 2023; and U.S. Provisional Patent Application No. 63/546,703 filed on Oct. 31, 2023, each of which are hereby incorporated by reference in its entirety.

### TECHNICAL FIELD

This disclosure relates generally to wireless communications systems, and more particularly to methods and apparatus for multi-traffic relay transmission.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

### SUMMARY

Embodiments of the present disclosure provide methods and apparatus for multi-traffic relay transmission.

In one embodiment, a method of wireless communication performed by a wireless device, the method comprising: receiving, from a source node, an indication of relay capabilities for multi-traffic transmission; receiving a message from the source node indicating that the message is for relay operations; and relaying the message to a destination node.

In another embodiment, a wireless device comprises a transceiver, and a processor operably coupled to the transceiver. The processor is configured to: receive, from a source node, an indication of relay capabilities for multi-traffic transmission; receive a message from the source node indicating that the message is for relay operations; and relay the message to a destination node.

In yet another embodiment, a source node comprises a transceiver, and a processor operably coupled to the transceiver. The processor configured to: send an indication of relay capabilities for multi-traffic transmission to a wireless device; and send a message to the wireless device indicating that the message is for relay operations.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of”, when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3A illustrates an example of downlink (DL) multi-traffic from an access point (AP) to a relay and a station (STA) according to embodiments of the present disclosure;

FIG. 3B illustrates an example of uplink (UL) multi-traffic from an AP to a relay and a STA according to embodiments of the present disclosure;

FIG. 3C illustrates an example of multi-traffic indication according to embodiments of the present disclosure;

FIG. 4 illustrates an example of relay operation with multiple traffic according to embodiments of the present disclosure;

FIG. 5 illustrates an example of locating multi-traffic using aggregate medium access control (MAC) service data unit (A-MSDU) encapsulation according to embodiments of the present disclosure;

FIG. 6 illustrates an example of locating multi-traffic using aggregate medium access control (MAC) protocol data unit (A-MPDU) encapsulation according to embodiments of the present disclosure;

FIG. 7A illustrates an example of an MPDU delimiter (non-directional multi-gigabit (DMG)) for relay traffic indication according to embodiments of the present disclosure;

FIG. 7B illustrates an example of an MPDU delimiter (DMG) for relay traffic indication according to embodiments of the present disclosure;

FIG. 8 illustrates an example of locating multi-traffic in a two-dimensional bitmap according to embodiments of the present disclosure;

FIG. 9 illustrates an example of two-hop relaying according to embodiments of the present disclosure;

FIG. 10 illustrates an example of address extension and traffic address indication according to embodiments of the present disclosure;

FIG. 11 illustrates an example of regenerating the physical layer protocol data unit (PPDU) using decode-and-forward (DF) for different destination STAs according to embodiments of the present disclosure;

FIG. 12 illustrates an example flow diagram illustrating a method performed at the relay side according to embodiments of the present disclosure;

FIG. 13 illustrates an example multi-link operation (MLO) for relay transmission according to embodiments of the present disclosure;

FIG. 14 illustrates an example using orthogonal frequency-division multiple access (OFDMA) for relay transmission according to embodiments of the present disclosure;

FIG. 15A illustrates an example of relay transmission without transmit opportunity (TXOP) sharing according to embodiments of the present disclosure;

FIG. 15B illustrates an example of relay transmission with TXOP sharing according to embodiments of the present disclosure;

FIG. 16A illustrates an example of a traditional relay according to embodiments of the present disclosure;

FIG. 16B illustrates an example of a relay that co-exists with an AP according to embodiments of the present disclosure;

FIG. 16C illustrates an example of a relay that co-exists with a non-AP STA according to embodiments of the present disclosure;

FIG. 17 illustrates an example of TXOP sharing for a second hop according to embodiments of the present disclosure;

FIG. 18 illustrates an example trigger frame format for relayed TXOP sharing according to embodiments of the present disclosure;

FIG. 19 illustrates an example flow diagram of a method performed by an AP for relay transmission in DL according to embodiments of the present disclosure;

FIG. 20 illustrates an example flow diagram of a method performed by a relay STA for relay transmission in DL according to embodiments of the present disclosure;

FIG. 21 illustrates an example flow diagram of a method performed by a destination STA for relay transmission in DL according to embodiments of the present disclosure;

FIG. 22 illustrates an example of TXOP sharing for first and second hops according to embodiments of the present disclosure;

FIG. 23 illustrates an example DL TXOP returning and utilization of CF-end according to embodiments of the present disclosure;

FIG. 24 illustrates an example UL TXOP returning with CF-end forwarding according to embodiments of the present disclosure;

FIG. 25 illustrates an example of TXOP sharing for UL according to embodiments of the present disclosure;

FIG. 26 illustrates an example flow diagram of a method performed by an AP for UL transmission with Option 1 (described herein) according to embodiments of the present disclosure;

FIG. 27 illustrates an example flow diagram of a method performed by a relay STA for UL transmission with Option 1 according to embodiments of the present disclosure;

FIG. 28 illustrates an example flow diagram of a method performed by a destination STA for UL transmission with Option 1 according to embodiments of the present disclosure;

FIG. 29 illustrates an example flow diagram of a method performed by an AP for UL transmission with Option 2 (described herein) according to embodiments of the present disclosure;

FIG. 30 illustrates an example flow diagram of a method performed by a relay STA for UL transmission with Option 2 according to embodiments of the present disclosure;

FIG. 31 illustrates an example flow diagram of a method performed by a destination STA for UL transmission with Option 2 according to embodiments of the present disclosure;

FIG. 32 illustrates example scenarios of Option 1 and Option 2 according to embodiments of the present disclosure;

FIG. 33 illustrates an example of an implicit acknowledgement (ACK) in a DL scenario according to embodiments of the present disclosure;

FIG. 34 illustrates an example of an implicit ACK in a UL scenario according to embodiments of the present disclosure;

FIG. 35 illustrates an example TXOP sharing an implicit ACK support field according to embodiments of the present disclosure;

FIG. 36 illustrates an example TXOP sharing for a second hop with multiple destination STAs according to embodiments of the present disclosure;

FIG. 37 illustrates an example multi-user request to send (MU-RTS) TXOP sharing (TXS) for second hop with multiple destination STAs according to embodiments of the present disclosure;

FIG. 38 illustrates an example of TXOP sharing in relay transmission with multi-traffic according to embodiments of the present disclosure;

FIG. 39 illustrates an example of the categories of networks according to embodiments of the present disclosure;

FIG. 40 illustrates an example relay multi-traffic capabilities information element according to embodiments of the present disclosure;

FIG. 41 illustrates an example relay capabilities information field format according to embodiments of the present disclosure;

FIG. 42 illustrates an example of TXOP sharing for relay transmission with multi-traffic: DL from AP to the relay STA according to embodiments of the present disclosure;

FIG. 43 illustrates another example of TXOP sharing for relay transmission with multi-traffic: DL from AP to the relay STA according to embodiments of the present disclosure;

FIG. 44 illustrates another example of TXOP sharing for relay transmission with multi-traffic: DL from AP to the relay STA according to embodiments of the present disclosure;

FIG. 45 illustrates an example flow diagram of a method performed by an AP for multi-traffic: UL from the relay to the AP according to embodiments of the present disclosure;

FIG. 46 illustrates an example flow diagram of a method performed by a relay STA for multi-traffic: UL from the relay to AP according to embodiments of the present disclosure;

FIG. 47 illustrates an example flow diagram of a method performed by THE DESTINATION STA for multi-traffic: UL from relay to AP according to embodiments of the present disclosure;

FIG. 48 illustrates an example of TXOP sharing for relay transmission with multi-traffic: DL peer-to-peer (P2P) with request and response negotiation according to embodiments of the present disclosure;

FIG. 49 illustrates an example flow diagram of a method performed by an AP for multi-traffic: P2P between the relay and the destination STA according to embodiments of the present disclosure;

FIG. 50 illustrates an example flow diagram of a method performed by a relay STA for multi-traffic: P2P between the relay and the destination STA according to embodiments of the present disclosure;

FIG. 51 illustrates an example flow diagram of a method performed by a destination STA for multi-traffic: P2P between the relay and the destination STA according to embodiments of the present disclosure;

FIG. 52 illustrates an example of TXOP sharing for relay transmission with multi-traffic: DL P2P with triggered negotiation according to embodiments of the present disclosure;

FIG. 53 illustrates an example of TXOP sharing for relay transmission with multi-traffic: UL P2P according to embodiments of the present disclosure;

FIG. 54 illustrates an example of multi-traffic in multi-link operation (MLO) according to embodiments of the present disclosure; and

FIG. 55 illustrates an example flow diagram of a method for wireless communication performed by a wireless device according to embodiments of the present disclosure.

### DETAILED DESCRIPTION

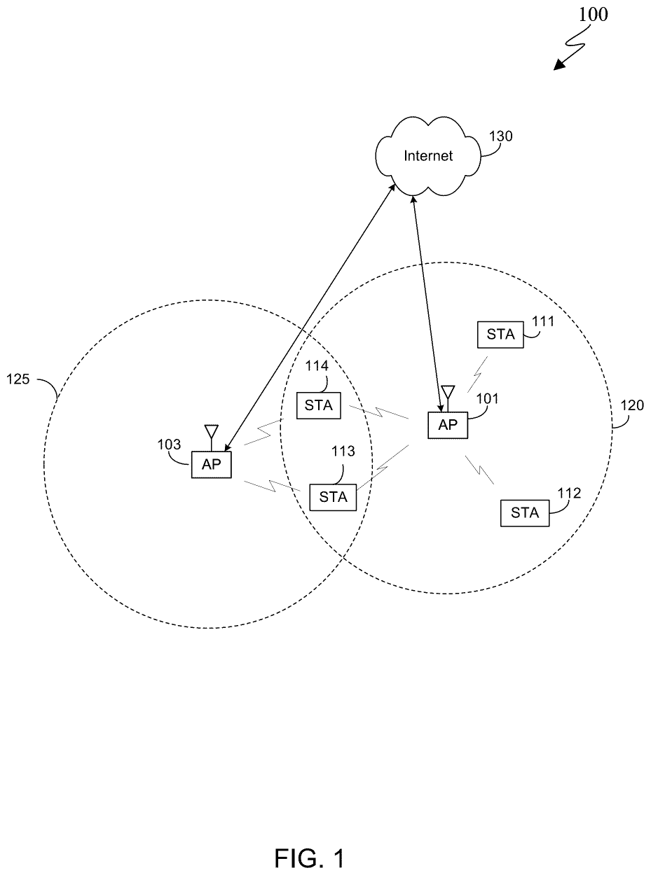

FIGS. 1 through 55, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-traffic relay transmission. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

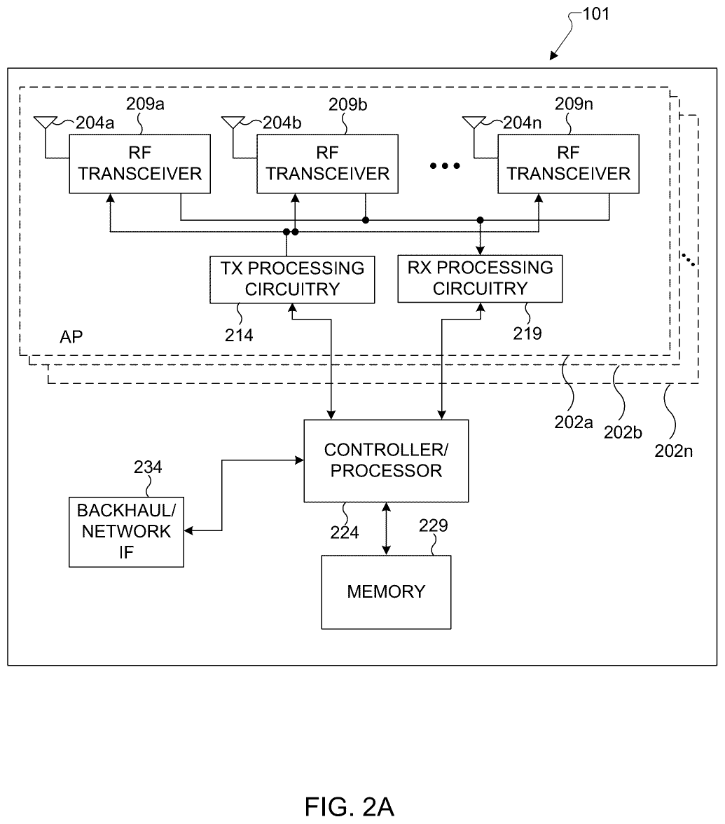

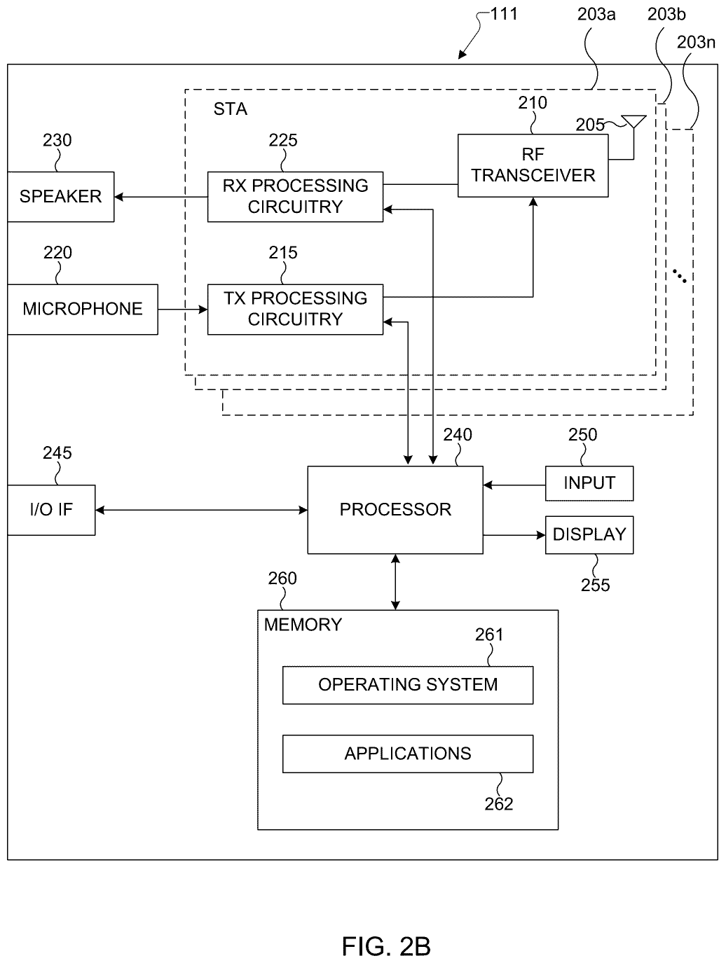

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating multi-traffic relay transmission. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating multi-traffic relay transmission. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate multi-traffic relay transmission. In some embodiments, the processor 240 includes at least one microprocessor or microcontroller.

The processor 240 is also capable of executing other processes and programs resident in the memory 260, such as operations for facilitating multi-traffic relay transmission. The processor 240 can move data into or out of the memory 260 as required by an executing process. In some embodiments, the processor 240 is configured to execute a plurality of applications 262, such as applications for facilitating multi-traffic relay transmission. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Various embodiments of the present disclosure recognize that a relay can be applied to improve the Rate-vs-Range for ultra-high reliability (UHR). In the existing standards, relay is usually considered as a helper/amplifier for range extension, for example, relay may support other STAs that may have poor channel state information, or at the edge of a cell. A STA serving as a relay may have its own DL/UL traffic. Ideally, the UHR relay STA could be a non-AP STA with relay functionality. However, it is not known how to realize such new functionality, that is, the AP may transmit multi-traffic for not only the relay STA but also for other destination STAs who need to boost performance with the help of the relay STA.

Accordingly, various embodiments of the present disclosure propose a relay that can be a type of STA which may have relay functionality. For example, a relay can be a Mobile AP multi-link device (MLD), a non-AP MLD, a legacy STA with relay functionality, etc. The various embodiments are applicable for both multi-link operation (MLO) as well as non-MLO operation.

Relay has been important in WiFi and cellular networks. It plays an important role in extending coverage and improving connectivity. Relays act as intermediaries that receive and transmit signals between the main router and devices in areas with weak reception. By strategically placing relays, the dead zones can be effectively eliminated and maintained strongly. This is especially important in larger homes or malls where the signals of the access points (AP) might not reach every corner. Relays help ensure a seamless browsing and streaming experience, promoting better productivity and user satisfaction.

There are many standards have been developed on this topic. For example, 802.11s mesh networks, 802.11ah (S1G relay) HaLow, 802.11ad (DMG relay), and 3GPP also has considered side link relay which is outside the scope of WLAN.
1. 802.11s Mesh Networks: 802.11s is designed to create self-organizing mesh networks where nodes (devices) relay data for one another, forming a dynamic network topology. Mesh networks are resilient, as they can adapt to changes in the network layout or node failures. Relays in 802.11s help route traffic efficiently, allowing devices to communicate directly or through other nodes, resulting in better coverage and reduced congestion.
2. 802.11ah (HaLow) S1G Relay: This standard is designed for long-range, low-power communication, making it ideal for Internet of Things (IoT) devices. The S1G relay in 802.11ah extends coverage in environments with low data rates, enabling devices with limited power to communicate over longer distances. It's especially useful for applications like smart agriculture or industrial automation where devices are spread out and require connectivity over a wide area.
3. 802.11ad (DMG) Relay: 802.11ad, also known as WiGig, operates in the 60 GHz frequency band and is focused on high-speed, short-range communication. DMG relays facilitate communication in scenarios like wireless docking, virtual reality, and high-definition multimedia streaming. Relays in this context enhance the range and coverage of these high-speed connections, ensuring a reliable and seamless experience.
4. 3GPP Sidelink Relay: While not strictly WiFi, 3GPP standards involve cellular communication. Sidelink relay is a concept in cellular networks where devices communicate directly with each other without going through a base station. This can be particularly useful in scenarios where the network infrastructure might be overloaded, such as in crowded events or emergency situations. Sidelink relays enhance device-to-device communication, improving overall network efficiency.

All these relay technologies share the common goal of extending coverage, improving connectivity, and enhancing overall network performance in various scenarios, whether it's for IoT, high-speed multimedia, mesh networking, or direct device-to-device communication.

In general, all those standards are not designed for UHR STAs, where the bands supported are 2.4 GHz, 5 GHz, and 6 GHz. The limitations for the existing standards can be summarized as below:

### 1. 802.11s Mesh Networks

Complex network management: While mesh networks offer self-organizing capabilities, managing the routing and topology of such networks can be complex. Optimizing the network to avoid routing loops and ensure efficient data paths can be challenging.
Latency: In multi-hop mesh networks, each relay introduces some latency. The more hops data has to traverse, the higher the latency can become. This can be a concern for applications that require low-latency communication.

### 2. 802.11ah (HaLow) S1G Relay

Limited data rates: While 802.11ah excels in providing long-range connectivity, its data rates are relatively low compared to other WiFi standards. This makes it less suitable for applications that require high-speed data transfer.
High cost: HaLow is not very successful in the market since the design is built top of 11ac, thus the final product for IoT devices could be too much expensive compared with its needs.

### 3. 802.11ad (DMG) Relay

Short range: The 60 GHz frequency used by 802.11ad has high attenuation, meaning its range is limited to a few meters. This restricts its applicability to short-range scenarios, making it less effective for providing coverage in larger areas.
Line-of-Sight requirement: The 60 GHz frequency band is highly sensitive to obstacles, including walls and other physical barriers. This means that devices need a clear line of sight for effective communication, limiting its usability in environments with obstacles.

### 4. 3GPP Sidelink Relay

Coverage and capacity challenges: While sidelink relay enhances device-to-device communication, it may still be limited by the coverage and capacity of the cellular network. In densely populated areas, the demand for sidelink relay may strain the network resources.
Interference and congestion: In crowded environments, multiple devices trying to establish sidelink connections can lead to interference and congestion issues, affecting the overall performance of the network.

It's important to note that each technology has its own set of trade-offs and is designed to address specific use cases and scenarios.

### [1] IEEE Std 802.11-2020

UHR SG (Ultra high reliability study group) which is the study group for next generation Wi-Fi standards design (IEEE 802.11bn) has set a number of objectives for next generation Wi-Fi network design. The group intends to achieve the ultra-high reliability target by reducing latencies to ultra-low values, increasing throughputs at different SNR levels, enhancing power savings, etc. To meet these objectives, the group intends to develop new protocols and concepts for performance improvement compared to Wi-Fi 7 [1]. One of the key objectives in UHR is to enhance Rate-vs-Range (RvR) performance in next generation Wi-Fi Networks. Thus, relay can be a candidate feature to improve the RvR performance in 11bn with different architecture and design.

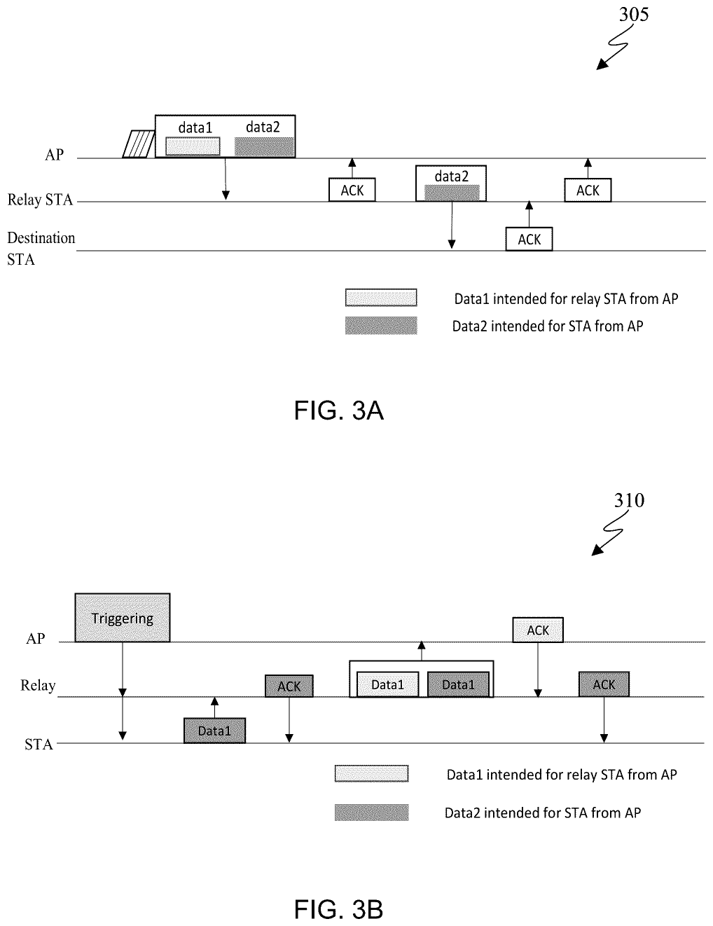

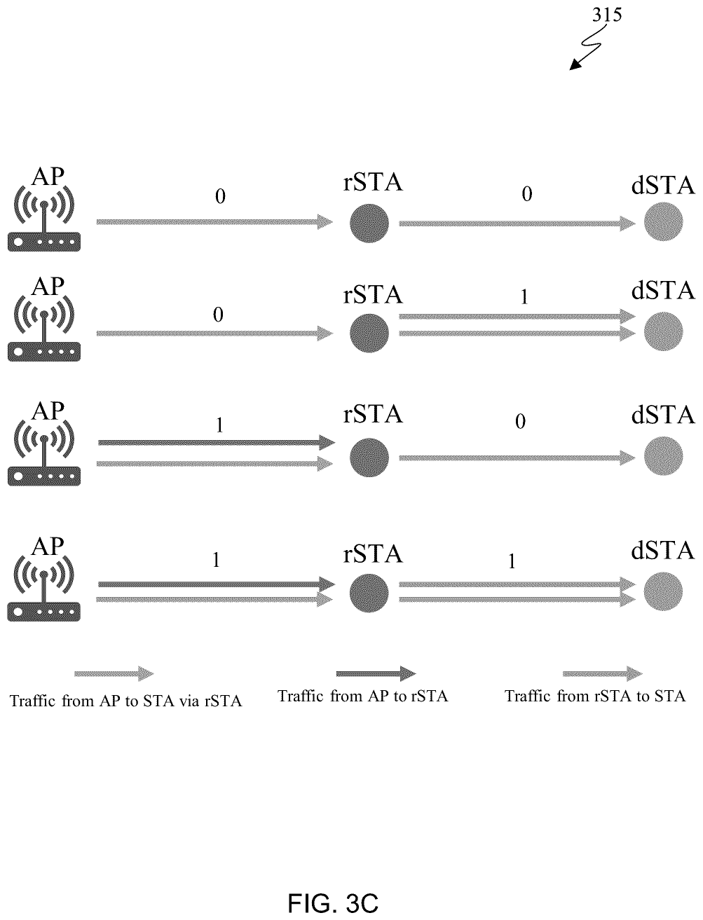

FIG. 3A illustrates an example of downlink (DL) multi-traffic from an access point (AP) to a relay and a station (STA) 305 according to embodiments of the present disclosure. The embodiment of the example of DL multi-traffic from an AP to a relay and a STA 305 shown in FIG. 3A is for illustration only. Other embodiments of the example of DL multi-traffic from an AP to a relay and a STA 305 could be used without departing from the scope of this disclosure.

FIG. 3B illustrates an example of uplink (UL) multi-traffic from an AP to a relay and a STA 310 according to embodiments of the present disclosure. The embodiment of the example of UL multi-traffic from an AP to a relay and a STA 310 shown in FIG. 3B is for illustration only. Other embodiments of the example of UL multi-traffic from an AP to a relay and a STA 310 could be used without departing from the scope of this disclosure.

As illustrated in FIGS. 3A and 3B, a STA serving as a relay may have its own DL/UL traffic. The AP may transmit more than one traffic. In this example, data1 is intended for the relay STA, and data2 is intended for the destination STA via the relay STA.

As described above, in the present disclosure, a relay can be a type of STA that may have relay functionality. The above functionality may be realized where the AP may transmit multiple traffic for a relay STA (rSTA) and a destination STA(s) (dSTA), in which the data for dSTAs is transmitted with the help of the rSTA(s). The solutions are divided into three sections:

In one embodiment, a general solution to realize such functionality is that, when the relay obtains the packets, it first locates and extracts its own message (data1). Then, it forwards the message (data2) to the destination STA, as shown in FIGS. 3A and 3B. The destination STA will receive the data2 from the relay STA originated from the AP.

In one embodiment, before starting transmitting data frames, the AP, relay STA, and/or destination STA may exchange the relay capabilities of multi-traffic from a relay capabilities information elements (IE), e.g., beacon, probe response, discovery, set up, etc., any management frames.

In one embodiment, during the data transmission phase, the relay STA may locate its own packets and also the packets for destination STA(s) by identifying the addresses in the PPDU that AP transmits.

In one embodiment, the relay may decide how to relay the packets, either by directly passing the packets, or it may regenerate new packets for the destination STAs.

FIG. 3C illustrates an example of multi-traffic indication 315 according to embodiments of the present disclosure. The embodiment of the example of multi-traffic indication 315 shown in FIG. 3C is for illustration only. Other embodiments of the example of multi-traffic indication 315 could be used without departing from the scope of this disclosure.

As illustrated in FIG. 3C, the multi-link indication may indicate whether the relay STA transmits and/or receives more than one traffic. In one embodiment, this may be one bit, at the AP-rSTA link, set to 0 means no additional DL/UL traffic except the relaying traffic. Set to 1 means have more than one traffic for the rSTA except the relaying frames. At the rSTA-dSTA, set to 0 means no additional DL/UL traffic except the relaying traffic. Set to 1 means there exists UL/DL between the rSTA-dSTA. This is just an example for one relay and one STA, the encoding could be adjusted.

In one embodiment, before the AP transmits the multi-traffic, it may indicate the relay capabilities IE in the frame such as the beacon, the association request/response, discovery, and RTS, etc. The relay capabilities IE may include the multi-traffic field which may contain the information items as described below in Table 1:

TABLE 1
Information items for enabling multi-traffic
can be presented in the management frames

| Infor- | | |
|---|---|---|
| mation | | |
| items | Description | Encoding |
| Relay | Indicates that relay STA is | Set to 1 if non-AP STA |
| support- | capable of relaying via itself | is supportable for |
| ability | by transmitting and receiving | relay functionality. |
| | frames between AP and | Otherwise set to 0. |
| | STAs. A STA capable of | |
| | relaying support is named | |
| | “relay STA”. | |
| Relay | Indicate that if the STA is | Set to 1 if an AP or a |
| usability | capable to use frame-relaying | non-AP STA (destination |
| | through a UHR relay STA. | STA which may need relay |
| | | assistance) is able to use |
| | | relay STA. |
| Relay | Indicates that how much a | The value is |
| preference | STA prefers to become a | implementation- |
| | relay-functioned STA | dependent. A higher value |
| | compared with a normal STA. | indicates a higher |
| | | preference and possibility |
| | | to become a relay STA. |
| Multi-traffic | Indicates whether the relay | This is one bit, at AP-rSTA |
| Indication | STA transmits and/or receives | link, 0 means no additional |
| (AP-rSTA | more than one traffic (as | DL/UL traffic except the |
| link, and | illustrated in FIG. 3C). | relaying traffic. Set to 1 |
| rSTA-dSTA | | means have more than one |
| link) | | traffic for rSTA except the |
| | | relaying frames. At rSTA- |
| | | dSTA, Set to 0 means no |
| | | additional DL/UL traffic |
| | | except the relaying traffic. |
| | | Set to 1 means there exists |
| | | UL/DL between Rsta- |
| | | dSTA. |
| | | An illustration example is |
| | | shown in the left. This is |
| | | just an example for one |
| | | relay and one STA, the |
| | | encoding could adjust |
| | | based on the needs. |
| AP capacity | Indicates the maximum | The value is |
| for relay | number of relay that an | implementation- |
| | AP can hold in its BSS. | dependent. |
| Capacity of | Indicates the maximum | The value is |
| Relay | number of hops in one | implementation- |
| Multi-hop | relaying-frame transmission. | dependent. |
| Capacity of | Indicates the maximum | The value is |
| dSTA | number of the destination | implementation- |
| | STAs each relay may support. | dependent. |
| Duplex | Indicates whether rSTA is | Set to 01 if rSTA is |
| | capable for FD or HD. | capable only for FD. Set to |
| | | 10 if rSTA is capable only |
| | | for HD. Set to 11 if rSTA |
| | | is capable for both. 00 is |
| | | reserved. |
| Relaying | Indicates whether rSTA is | Set to 01 if rSTA is |
| mode | capable for AF or DF, | capable only for AF. Set to |
| | or both. | 10 if rSTA is capable only |
| | | for DF. Set to 11 if rSTA is |
| | | capable for both. 00 is |
| | | reserved. |
| Address | Indicates the address of the | Can be another field to |
| Extension | source rSTA and destination | indicates. |
| | rSTA if exists multiple hops. | |
| Number of | Indicates the order and | The value is |
| frames used | number information of the | implementation- |
| for relay | frames that are specifically | dependent. |
| | reserved for relay | |
| | transmission if the multi- | |
| | traffic indications are not | |
| | all zeros. | |

According to another embodiment, the Multi-traffic Indication can also be designed into two bits. For example, set to 00 if the AP-rSTA-dSTA are not allowed to have multiple DL/UL traffic during the relaying procedure. Set to 01 if the rSTA-dSTA link may be allowed to have multiple traffic, in this case, the AP will allow the P2P transmission between the rSTA and the destination STA. Set to 10 if the AP-rSTA link may allow multiple traffic. Set to 11 if the AP-rSTA-dSTA are all capable to enable multiple DL/UL traffic besides relaying frames.

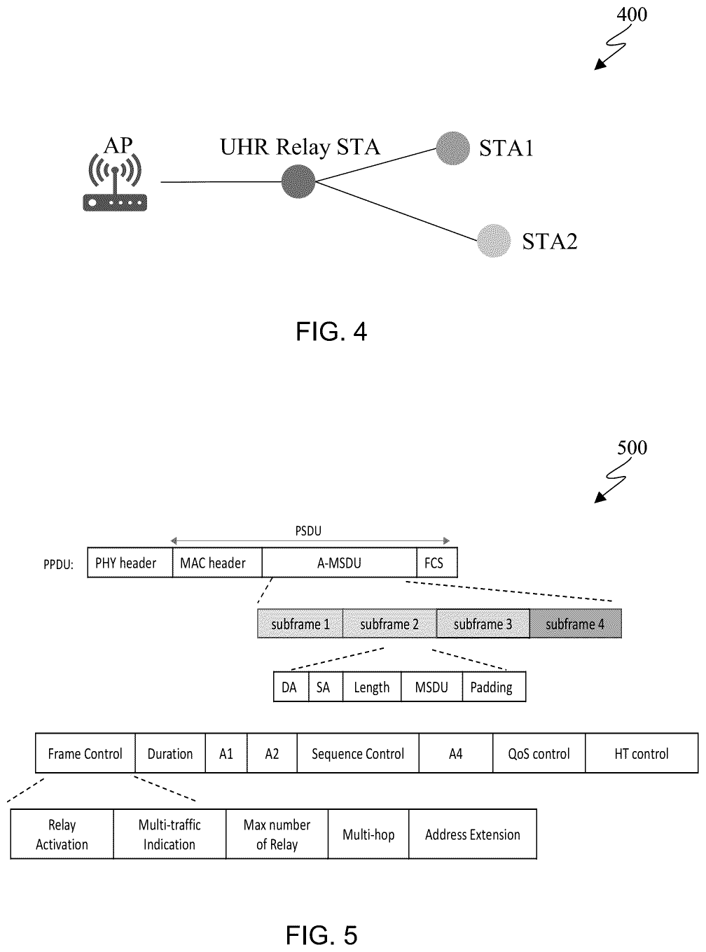

FIG. 4 illustrates an example of relay operation with multiple traffic 400 according to embodiments of the present disclosure. The example of relay operation with multiple traffic 400 shown in FIG. 4 is for illustration only. Other embodiments of the example of relay operation with multiple traffic 400 could be used without departing from the scope of this disclosure.

As illustrated in FIG. 4, an AP may be coupled to a UHR relay STA. The multi-traffic information for STA1 and/or STA2 may be transmitted from the AP through the UHR relay STA.

FIG. 5 illustrates an example of locating multi-traffic using A-MSDU encapsulation 500 according to embodiments of the present disclosure. The example of locating multi-traffic using A-MSDU encapsulation 500 shown in FIG. 5 is for illustration only. Other embodiments of the example of locating multi-traffic using A-MSDU encapsulation 500 could be used without departing from the scope of this disclosure.

In one embodiment, STAs and the relay STA may locate their own DL data using Aggregate MAC Service Data Unit (A-MSDU) encapsulation. There will be multiple subframes concatenated together to form an A-MSDU payload. An example of the design of the A-MSDU frames for the relay STA and other STAs is shown in FIG. 5. In this scenario, as illustrated in FIG. 4, the AP may have three unicast information to transmit in one PPDU for the UHR relay STA, STA1, and STA2. The information for STA1 and STA2 is transmitted through the UHR relay STA. An example PPDU is illustrated in FIG. 5. To allow one packet to carry the information for three nodes, the A-MSDU may relax the assumption that all subframes have to be addressed to the same RA. In this example, when the AP encodes the PPDU, it could set the first two subframes, subframe 1 and subframe 2 for STA2, subframe 3 for STA1, and subframe 4 for the UHR relay STA. Then the address from the AP to the relay STA could be A1(RA)=Relay, A2(TA)=AP, A3(DA)=STA2, A4(SA)=AP for subframe 1 & 2. A1(RA)=Relay, A2(TA)=AP, A3(DA)=STA1, A4(SA)=AP for subframe 3. A1(RA)=Relay, A2(TA)=AP, A3(DA)=Relay, A4(SA)=AP for subframe 4. The address from the relay to the STA will become A1(RA)=STA2, A2(TA)=Relay, A3(DA)=STA2, A4(SA)=AP for subframe 1 & 2. A1(RA)=STA1, A2(TA)=Relay, A3(DA)=STA1, A4(SA)=AP for subframe 3. Subframe 4 could either be removed from the A-MSDU or the packet could be maintained depending on the relaying mode of AF or DF.

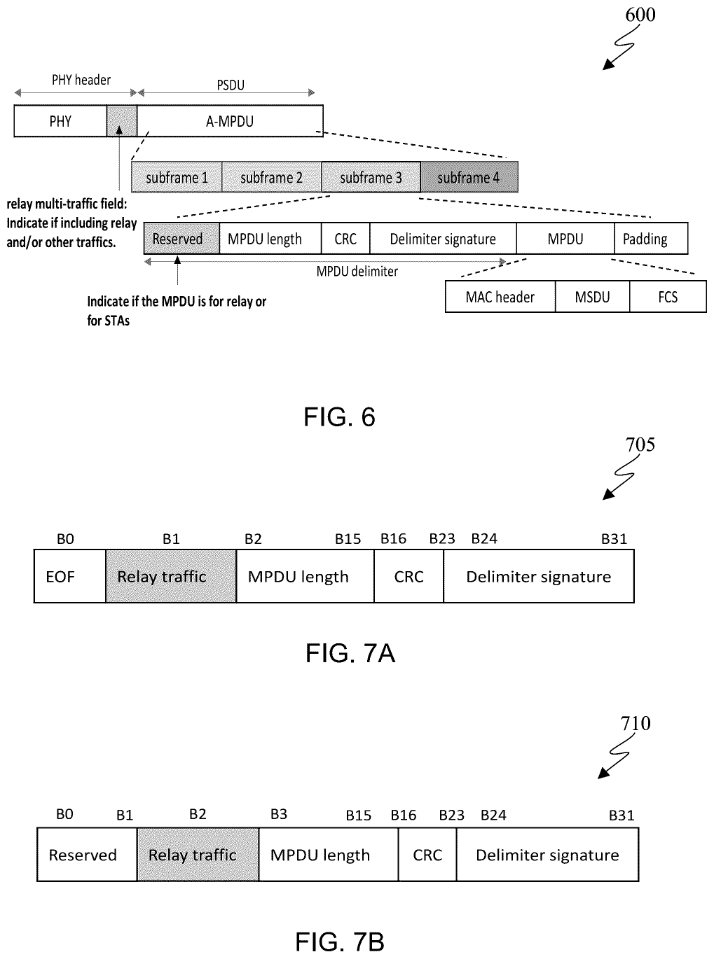

FIG. 6 illustrates an example of locating multi-traffic using A-MPDU encapsulation 600 according to embodiments of the present disclosure. The example of locating multi-traffic using A-MPDU encapsulation 600 shown in FIG. 6 is for illustration only. Other embodiments of the example of locating multi-traffic using A-MPDU encapsulation 600 could be used without departing from the scope of this disclosure.

FIG. 7A illustrates an example of an MPDU delimiter (non-directional multi-gigabit (non-DMG)) for relay traffic indication 705 according to embodiments of the present disclosure. The example of an MPDU delimiter (non-DMG) for relay traffic indication 705 shown in FIG. 7A is for illustration only. Other embodiments of the example of an MPDU delimiter (non-DMG) for relay traffic indication 705 could be used without departing from the scope of this disclosure.

FIG. 7B illustrates an example of an MPDU delimiter (DMG) for relay traffic indication 710 according to embodiments of the present disclosure. The example of an MPDU delimiter (DMG) for relay traffic indication 710 shown in FIG. 7B is for illustration only. Other embodiments of the example of an MPDU delimiter (DMG) for relay traffic indication 710 could be used without departing from the scope of this disclosure.

In one embodiment, the STAs and the relay STA may locate their own DL data using Aggregate MAC Protocol Data Unit (A-MPDU) encapsulation. An A-MPDU includes a sequence of one or more A-MPDU subframes. Each A-MPDU subframe includes an MPDU delimiter, an MPDU, and padding. First, the multi-traffic indication field as described in Table. 1 may be included in the PHY header. Second, one way to indicate if the MPDU is for relay or for STAs is to reuse some reserved bits in the MPDU. For example, the reserved bits in the MPDU delimiter may be considered. If UHR supports one STA via a relay, which assumes only STA1 and no STA2 in FIG. 4, then one reserved bit in the MPDU delimiter may be used to indicate if the subframe is for relay traffic or not. For example, if the multi-traffic indication bit at the AP to rSTA link is 0 indicated in the PHY header, the subframes in this link may only include the traffic for the destination STA, and thus, each relay traffic indication field in the MPDU delimiter is set zero. Otherwise, the multi-traffic indication bit at the AP to rSTA link is 1 which indicates multi-traffic at this link, then the relay traffic indication at subframe 4 is set to 1 referring to the relay traffic. An example of the delimiter design is shown in FIG. 7A for non-DMG and in FIG. 7B for DMG.

According to another embodiment, the indication could also be included in the header of MSDU frames.

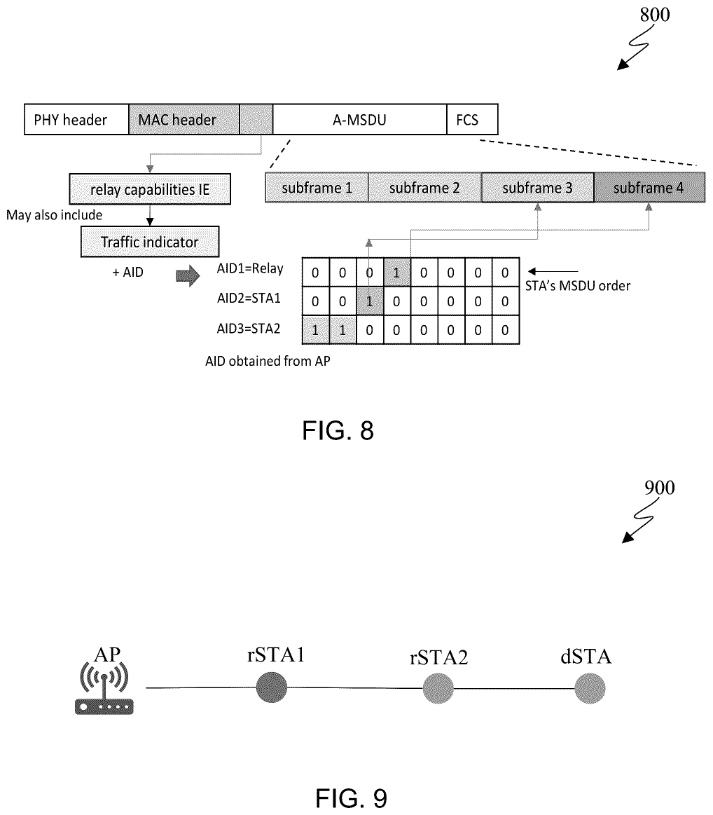

FIG. 8 illustrates an example of locating multi-traffic in a two-dimensional bitmap 800 according to embodiments of the present disclosure. The example of locating multi-traffic in a two-dimensional bitmap 800 shown in FIG. 8 is for illustration only. Other embodiments of the example of locating multi-traffic in a two-dimensional bitmap 800 could be used without departing from the scope of this disclosure.

In one embodiment, a 2-dimension bitmap to indicate the multi-traffic is utilized. First, in the MAC header or frame body, the relay transmission is indicated in the relay capabilities IE, the traffic indication together with the AID may be needed for the 2D bitmap. An example is shown in FIG. 8. Each row represents the nodes which can be labeled by AID, while each column denotes the TID. For instance, the first row is for relay with AID1=relay, and the fourth column is bit 1 indicating the traffic happens in the fourth subframe, which in this example, is for relay. The AID2=STA1 and TID is 1 in the second row third column which means the third subframe is the traffic for STA1. In such case, the DA and SA may not have to be changed as described above, and may follow the spec. The 2D bitmap is then easy for the relay to extract its own information and reframe the packets for relaying.

This embodiment will also need to forward the AID if the destination STAs are originally out of the range of the AP.

In one embodiment, for the downlink case, the relay traffic can also be fixed to a few beginning or last subframes in A-MSDU or PSDU or PPDU by the AP if the multi-traffic is allowed. For the uplink case, the relay can also append its own traffic to the relaying UL traffic from the destination STA to the AP at the end or beginning of the A-MSDU or PSDU or PPDU. The information for which traffic are from the relay can be indicated in the relay capacities IE modified by AP for DL or relay for UL.

FIG. 9 illustrates an example of two-hop relaying 900 according to embodiments of the present disclosure. The example of two-hop relaying 900 shown in FIG. 9 is for illustration only. Other embodiments of the example of two-hop relaying 900 could be used without departing from the scope of this disclosure.

In one embodiment, as illustrated in FIG. 9, to extend one or more of the above embodiments described herein into multi-hop scenarios, the address design in the 11s mesh network could be for multiple hop UHR relay STA utilization. At the same time, the source and destination of the traffic may be denoted if the multi-traffic is allowed.

For example, there will be 12 possibilities for the multi-traffic in the above two hops scenarios, the main traffic is from the AP to the destination STA via the two relay STAs, rSTA1, and rSTA2. There will be other possible transmissions along the main traffic if allowing the traffic between the nodes. For example, 5 possibilities in one hop: AP-RSTA1, AP-RSTA2, RSTA1-RSTA2, RSTA1-DSTA, RSTA2-DSTA; 6 possibilities in two-hops: AP-RSTA1, RSTA1-RSTA2; AP-RSTA1, RSTA1-DSTA; AP-RSTA1, RSTA2-DSTA; AP-RSTA2, RSTA2-DSTA; RSTA1-RSTA2, RSTA2-DSTA; AP-RSTA1, RSTA1-RSTA2, RSTA2-DSTA3. To indicate all the possibilities, the source address and destination address can be assigned in the address extension filed.

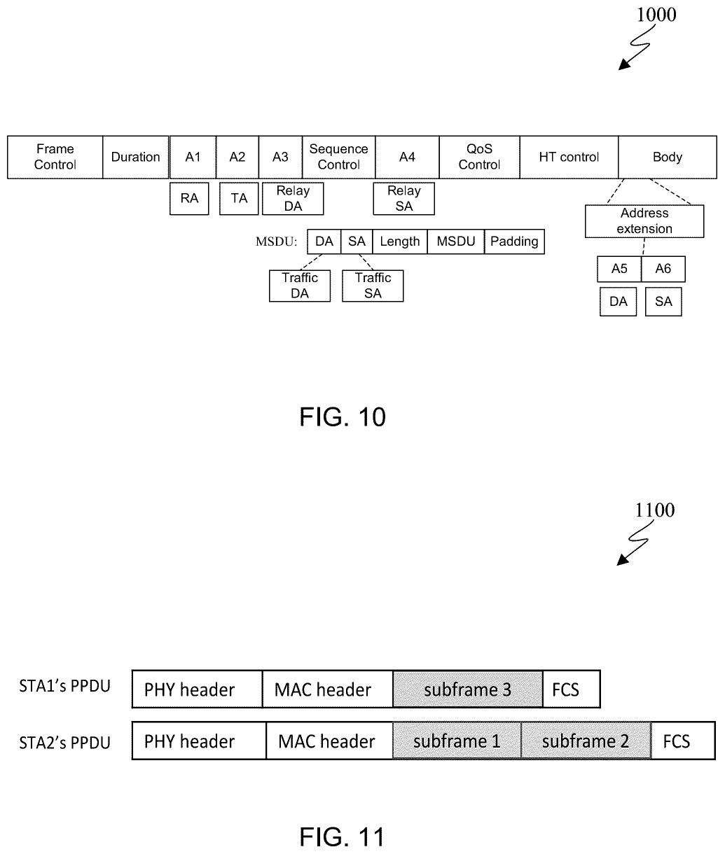

In addition, the traffic DA and traffic SA can be assigned into the MSDU, as illustrated in FIG. 10, which illustrates an example of address extension and traffic address indication 1000 according to embodiments of the present disclosure. The embodiment of the example of address extension and traffic address indication 1000 shown in FIG. 10 is for illustration only. Other embodiments of the example of address extension and traffic address indication 1000 could be used without departing from the scope of this disclosure.

The most common relaying strategies are decode-and-forward (DF) and amplify-and-forward (AF). A DF relay decodes, re-modulates, and retransmits the received signal. An AF relay amplifies and retransmits the signal without decoding.

In one embodiment (amplify and direct forward), after the relay STA locates and extracts its own packets, it could amplify and forward the relaying-frame directly to destination STAs. There is no need to trim the subframes of relays. Each destination STA may locate its own traffic according to one or more of the embodiments described herein.

FIG. 11 illustrates an example of regenerating the PPDU using DF for different destination STAs 1100 according to embodiments of the present disclosure. The embodiment of the example of regenerating the PPDU using DF for different destination STAs 1100 shown in FIG. 11 is for illustration only. Other embodiments of the example of regenerating the PPDU using DF for different destination STAs 1100 could be used without departing from the scope of this disclosure.

In one embodiment (decode and regenerate the packet and forward), which is suitable for DF, after the relay extracts its own packet, and also having the knowledge of where the relaying packets for the STAs are, the relay may regenerate the PPDUs based on the channel information between the relay and the STAs. For example, STA1 may use a different MCS compared with STA2, in which the corresponding MSDUs will be rebuilt by the relay. The relay may transmit the corresponding PPDUs to the STA in different channel resources or different time slots. An illustration is shown in FIG. 11.

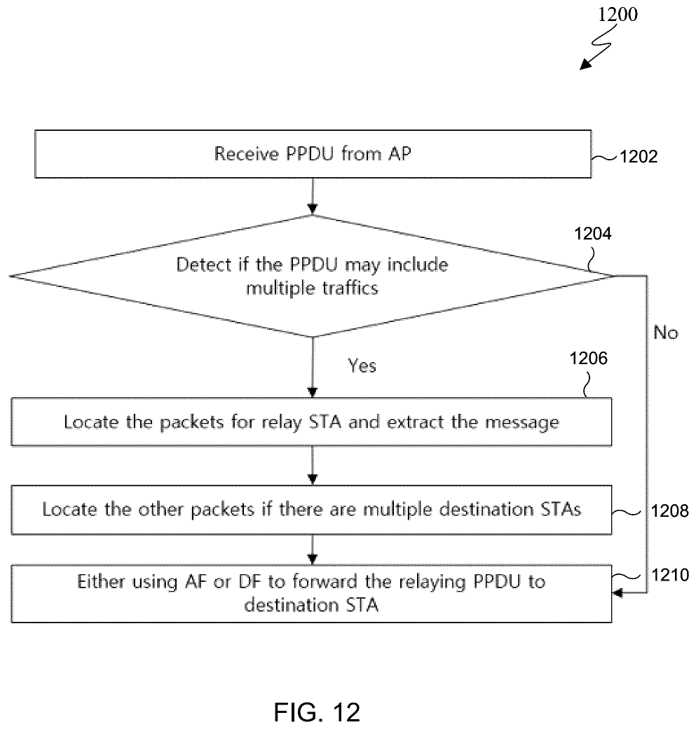

FIG. 12 illustrates an example flow diagram illustrating a method 1200 performed at the relay side according to embodiments of the present disclosure. The embodiment of the example method 1200 shown in FIG. 12 is for illustration only. Other embodiments of the example method 1200 could be used without departing from the scope of this disclosure.

As illustrated in FIG. 12, the method 1200 begins at step 1202, where the relay receives the PPDU from the AP. At step 1204, a determination is made whether the PPDU may include multi-traffic. If the PPDU contains multi-traffic, then at step 1206, the packets for the relay STA are located and the message is extracted. Thereafter, at step 1208, the other packets are located if there are multiple destination STAs. At step 1210, the relaying PPDU is forwarded to the destination STA using either AF or DF. If the PPDU does not contain multi-traffic at step 1204, then the method proceeds to step 1210 where the relaying PPDU is forwarded to the destination STA using either AF or DF.

The current IEEE specification has a rule about the A-MPDU, that is, all protected MPDUs within an A-MPDU have the same Key ID. To support multi-traffic transmission, this rule could be relaxed. The key ID and/or the encoding methods can be different for different dSTAs and rSTA(s) to ensure the security.

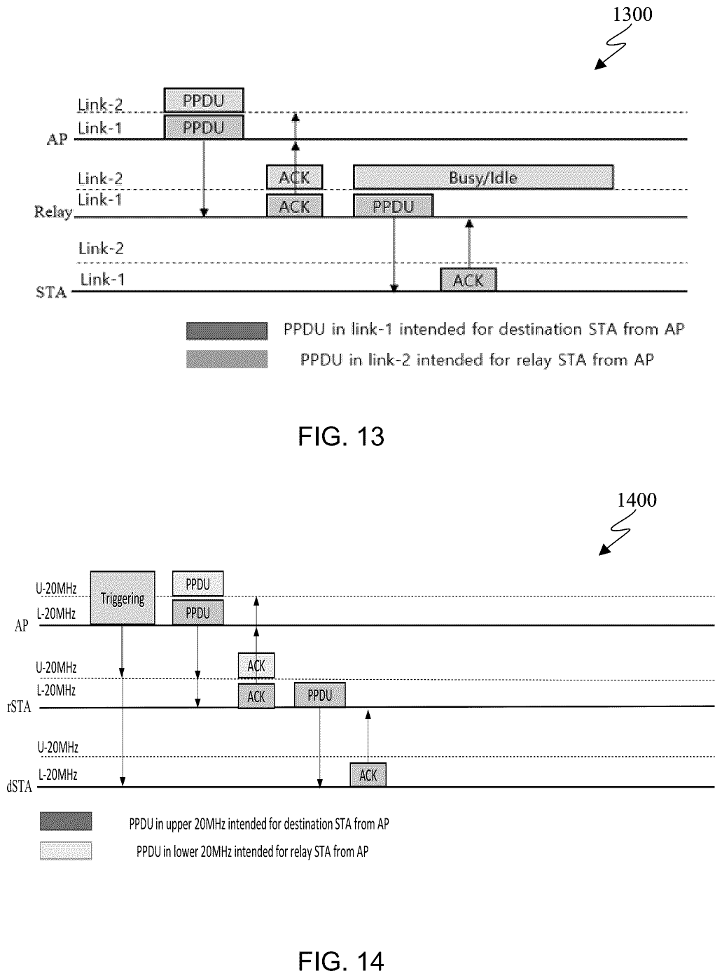

FIG. 13 illustrates an example multi-link operation (MLO) for relay transmission 1300 according to embodiments of the present disclosure. The embodiment of the example MLO for relay transmission 1300 shown in FIG. 13 is for illustration only. Other embodiments of the example MLO for relay transmission 1300 could be used without departing from the scope of this disclosure.

An alternative method can be using multilink devices (MLD) or OFDMA.

In one embodiment, the multi-traffic can be realized using MLO. The multi-traffic indication could be included in the multi-link setup procedure. The decision regarding the traffic which link may handle can be implementation dependent. An example is shown in FIG. 13. The AP may transmit the two different traffic via different links. Link-2 holds the DL PPDU from the AP to the relay STA, while Link-1 holds the DL relaying PPDU from the AP to the dSTA via the rSTA.

FIG. 14 illustrates an example using OFDMA for relay transmission 1400 according to embodiments of the present disclosure. The embodiment of the example using OFDMA for relay transmission 1400 shown in FIG. 14 is for illustration only. Other embodiments of the example using OFDMA for relay transmission 1400 could be used without departing from the scope of this disclosure.

In one embodiment, the multi-traffic can be realized using different frequency resources. An example is shown in FIG. 14. The lower 20 MHz is allocated for relaying frames. The upper 20 MHz is allocated for the traffic from the AP to the relay STA.

Various embodiments of the present disclosure recognize that relay can be a good candidate technology to extend the courage area and enhance the throughput in terms of Rate-vs-Range (RvR). Relays may forward frames between devices, thus, can extend the distance between the AP and edge STAs, and improve reliability in scenarios with obstructions. Relays may reduce energy consumed by STAs. STAs can transmit frames at lower power and at higher data rate due shorter transmission.

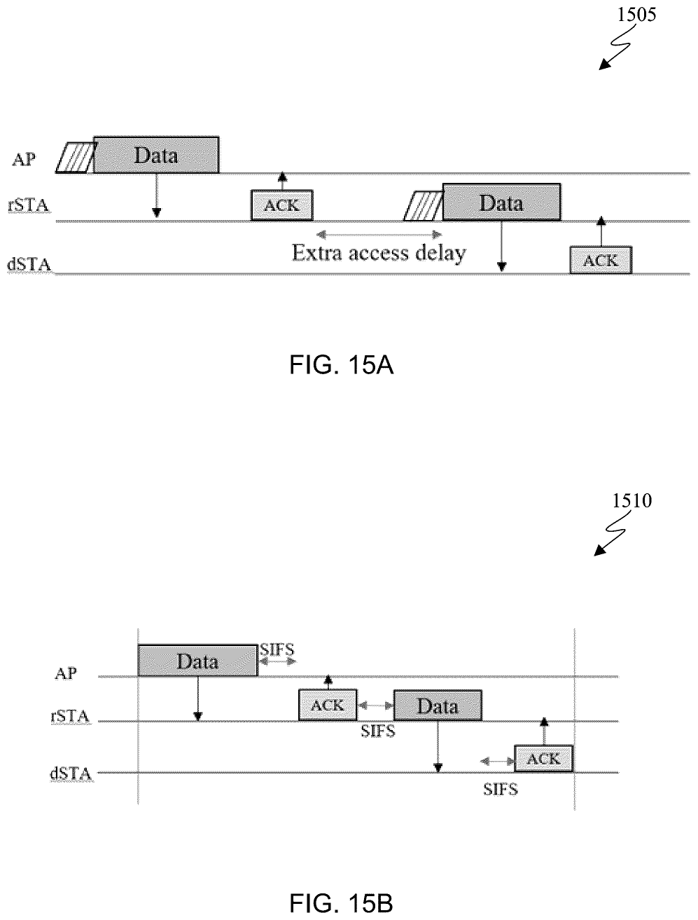

FIG. 15A illustrates an example of relay transmission without TXOP sharing 1505 according to embodiments of the present disclosure. The embodiment of the example of relay transmission without TXOP sharing 1505 shown in FIG. 15A is for illustration only. Other embodiments of the example of relay transmission without TXOP sharing 1505 could be used without departing from the scope of this disclosure.

FIG. 15B illustrates an example of relay transmission with TXOP sharing 1510 according to embodiments of the present disclosure. The embodiment of the example of relay transmission with TXOP sharing 1510 shown in FIG. 15B is for illustration only. Other embodiments of the example of relay transmission with TXOP sharing 1510 could be used without departing from the scope of this disclosure.

Various embodiments of the present disclosure recognize that in relay transmission, two transmissions should be considered, the one between the transmitter and the relay and the one between the relay and the receiver. Herein, to protect and guarantee the success for both sequential transmissions, a TXOP sharing procedure may be considered. Otherwise, more contentions for channel access may happen, which may increase the latency for data delivery. An example is seen in FIG. 15A. The TXOP sharing is to reduce the number of channel contentions to support efficient transmission, shown in FIG. 15B.

Accordingly, various embodiments of the present disclosure propose mechanisms for the types of relay nodes that can be considered in UHR. Further, various embodiments of the present disclosure propose mechanisms for TXOP sharing for DL transmission in a two-hop relay. In addition, various embodiments of the present disclosure propose mechanisms for TXOP sharing for UL transmission in a two-hop relay. Further still, various embodiments of the present disclosure propose mechanisms for explicit and implicit ACK in a relay-shared TXOP. In addition, various embodiments of the present disclosure propose mechanisms for TXOP sharing with multiple STAs.

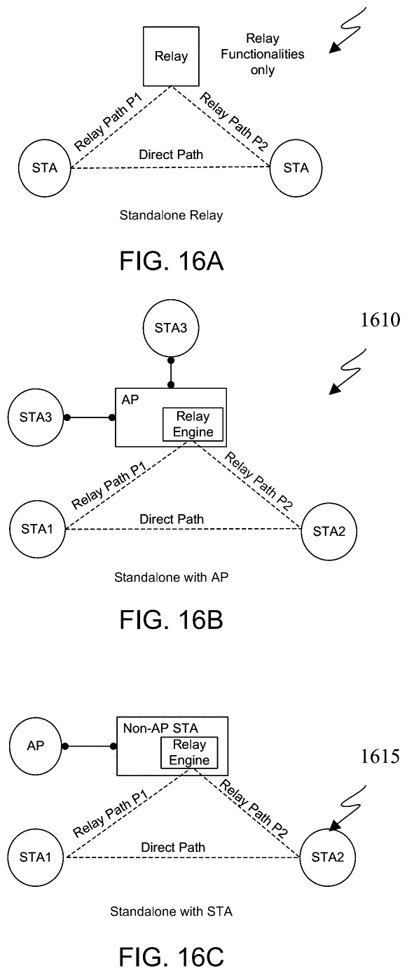

FIG. 16A illustrates an example of a traditional relay 1605 according to embodiments of the present disclosure. The embodiment of the example of a traditional relay 1605 shown in FIG. 16A is for illustration only. Other embodiments of the example of a traditional relay 1605 could be used without departing from the scope of this disclosure.

FIG. 16B illustrates an example of a relay that co-exists with an AP 1610 according to embodiments of the present disclosure. The embodiment of the example of a relay that co-exists with an AP 1610 shown in FIG. 16B is for illustration only. Other embodiments of the example of a relay that co-exists with an AP 1610 could be used without departing from the scope of this disclosure.

FIG. 16C illustrates an example of a relay that co-exists with a non-AP STA 1615 according to embodiments of the present disclosure. The embodiment of the example of a relay that co-exists with a non-AP STA 1615 shown in FIG. 16C is for illustration only. Other embodiments of the example of a relay that co-exists with a non-AP STA 1615 could be used without departing from the scope of this disclosure.

In various embodiments of the present disclosure, a relay node can be a newly defined device type. Its sole purpose is for helping a relaying operation. This can be a cheap way to enhance coverage and network performance. As illustrated in FIG. 16A, a relay node can be a traditional relay having relay functionality only. Alternatively, as illustrated in FIG. 16B, a relay node can co-exist with an AP node, i.e. the AP or AP MLD can implement relay functionalities. Alternatively, as illustrated in FIG. 16C, a relay node can co-exist with a non-AP STA node where the non-AP STA node can implement relay functionalities.

When a relay node receives a frame from a source node, where the frame is destined for a destination node, the relay node can take various actions for forwarding the frame to the destination node. The relay node, upon receiving the frame from the source node:
can simply forward the frame to the destination node without making any changes to the frame.
can amplify the power of the frame and then transmit the frame to the destination node (i.e., AF).
can decode the frame and then transmit the decoded information or part of the decoded information to the destination node (i.e., DF).

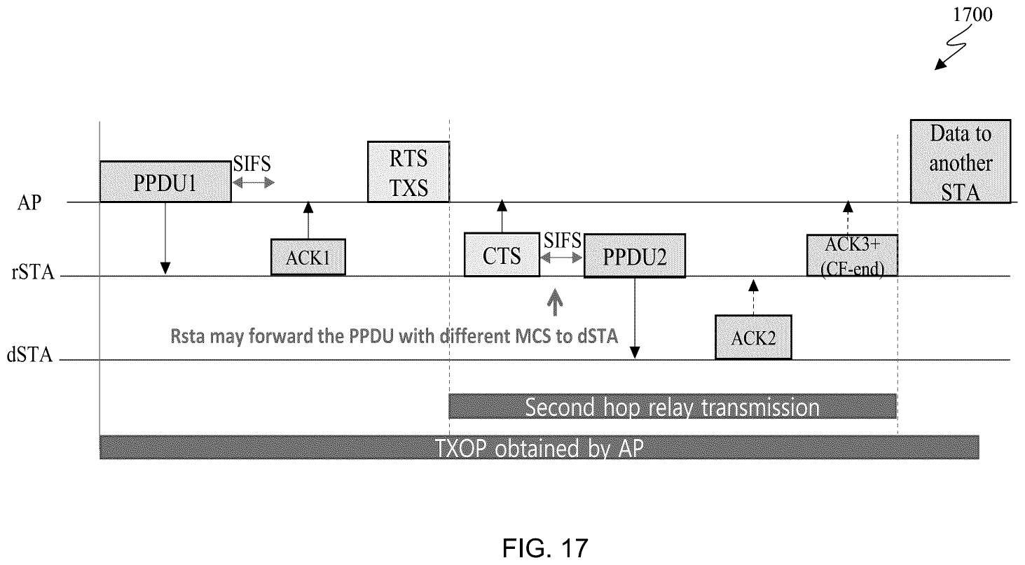

FIG. 17 illustrates an example of TXOP sharing for a second hop 1700 according to embodiments of the present disclosure. The embodiment of the example of TXOP sharing for a second hop 1700 shown in FIG. 17 is for illustration only. Other embodiments of the example of TXOP sharing for a second hop 1700 could be used without departing from the scope of this disclosure.

According to one embodiment, the triggered MU-RTS TXOP sharing (TXS) mode 2 defined in 11be can be reused for relaying-frame forwarding purpose. The RTS TXS mode 2 allows the AP to share its own TXOP to an associated STA, in mode 2, the STA can either transmit uplink PPDU to the AP or perform P2P to another STA. In relayed TXOP sharing, the rSTA should transmit the relaying frames to the destination STA in the shared TXOP, as illustrated in FIG. 17. First, the AP obtains the EDCA TXOP, and starts the relaying transmission by sending the PPDU1 to the relay STA. Then the AP sends the RTS TXS trigger frame after the SIFS time when receiving the ACK1 from the relay STA. Once the relay STA obtains the relayed TXOP, it releases its buffer and transmits the relaying frame PPDU2 to the destination STA. Once obtaining the ACK2 from the dSTA, the relay STA may provide a third ACK, ACK3 to the AP.

Some modification for the RTS TXS of 11be may be considered to enable the above procedure. The RTS TXS trigger frame may need to indicate the behaviors such as relay transmission of PPDU1 instead of a DL transmission for relay STA, and the relayed TXOP sharing for the second-hop transmission. The destination, source, and reception of PPDU1 may be needed so that the relay STA will know the PPDU1 is for relay purpose. The TXOP sharing for the second-hop transmission is to indicate that the relay may not need to contend the channel but wait for a TXS protection. The information list including the possible elements and fields is shown in Table 1.1.

TABLE 1.1
Information items may be considered in trigger frame

| Infor- | | |
|---|---|---|
| mation | | |
| items | Description | Encoding |
| Relayed | An information item could | Set to 1 if the TXOP is |
| TXOP | be in the Frame Control | enabled for relay |
| | Field or Common Info | transmission. Otherwise, |
| | Field. It may indicate the | not enable the relayed |
| | relayed TXOP is for the | TXOP. |
| | relaying transmission | |
| | (forward the PPDU1 to | |
| | destination STA via | |
| | relay STA). | |
| Number of | Indicate how many hops is | A value indicates the |
| hops | needed in the relay | number of hops. |
| | transmission. | |
| Enable | Indicate the TXOP is for | Set to 1 if the TXOP is for |
| first hop | first hop. | first hop only. Set to 0 if |
| protection | | the TXOP is not for the |
| | | first hop. |
| Enable | Indicate the TXOP is for | Set to 1 if the TXOP is for |
| second hop | second hop. | second hop only. Set to 0 if |
| protection | | the TXOP is not for the |
| | | second hop. |
| Enable | Indicate for which hops | Set to 11 if both hops are |
| first-second | the TXOP is assigned. | protected by TXOP; Set to |
| hop | | 10, if the first hop is |
| protection | | protected only; Set to 01, |
| (alternative) | | if the second hop is |
| | | protected only. 00 is |
| | | reserved. |
| UL or DL | Indicate if the TXOP is for | Set to 1 for UL, and set |
| | UL or DL relay | to 0 for DL. |
| | transmission. | |
| User Info | Indicate the destination and | Could be a field including |
| List | receiver's information. | the information of the user. |
| | | The users may include relay |
| | | and destination STA. |
| RTS TXS or | Indicate if the relay STA | Set the protection field to 1 |
| RTS/CTS | will need to contend the | if AP is going to assign a |
| protection | channel or wait for an RTS | protection. Set to 0 if there |
| indication | TXS protection. | is no protection. |
| TXOP | Indicate that if the STA is | Set the TXOP sharing |
| sharing | capable to use frame- | implicit ACK support field |
| implicit | relaying through a UHR | to 1 if the implementation |
| ACK support | relay STA. | of the implicit ACK is true. |
| | | if Otherwise, the STA may |
| | | set the TXOP sharing implicit |
| | | ACK support subfield to 0. |

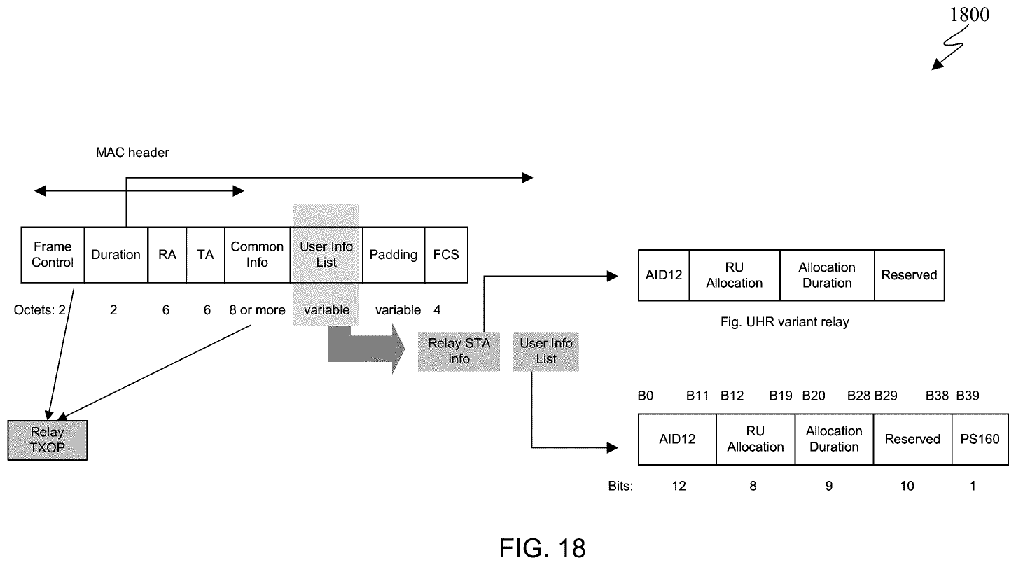

FIG. 18 illustrates an example trigger frame format for relayed TXOP sharing 1800 according to embodiments of the present disclosure. The embodiment of the example trigger frame format for relayed TXOP sharing 1800 shown in FIG. 18 is for illustration only. Other embodiments of the example trigger frame format for relayed TXOP sharing 1800 could be used without departing from the scope of this disclosure.

An example of the modified trigger frame is shown in FIG. 18. The relayed TXOP could be a field in Frame Control Field or Common Info Field. In an MU-RTS Trigger frame with relay functionality, the Duration field for DL case can be estimated: CTS+MaxPPDUlength (or the length of the PPDU in buffer)+3 or 4*SITS (depends on the ACK3)+1 or 2*ACKtime. The User Info List may contain the relay STA information which it plans to trigger. The AID of the relay STA can be assigned specifically or as normal. The RU allocated to the relay STA and destination STA should be the same, but not limited to. To indicate the address of the data frame, i.e., PPDU2 with RA(=dSTA), TA(=rSTA), DA(=dSTA), SA(=AP), we could enable the To DS=1, From DS=1, such as that in mesh BSSs, while extend to the UHR.

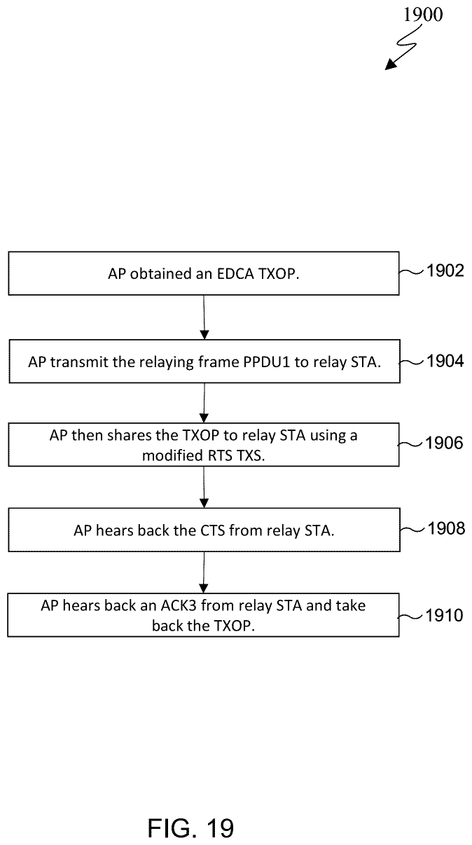

FIG. 19 illustrates an example flow diagram of a method 1900 performed by an AP for relay transmission in DL according to embodiments of the present disclosure. The embodiment of the method 1900 performed by an AP for relay transmission in DL shown in FIG. 19 is for illustration only. Other embodiments of the method 1900 performed by an AP for relay transmission in DL could be used without departing from the scope of this disclosure.

As illustrated in FIG. 19, the method 1900 begins at step 1902, where the AP obtains an EDCA TXOP. At step 1904, the AP transmits the relaying frame PPDU1 to the relay STA. At step 1906, the AP then shares the TXOP to the relay STA using a modified RTS TXS. At step 1908, the AP receives the clear to send (CTS) from the relay STA. At step 1910, the AP receives an ACK3 from the relay STA and takes back the TXOP.

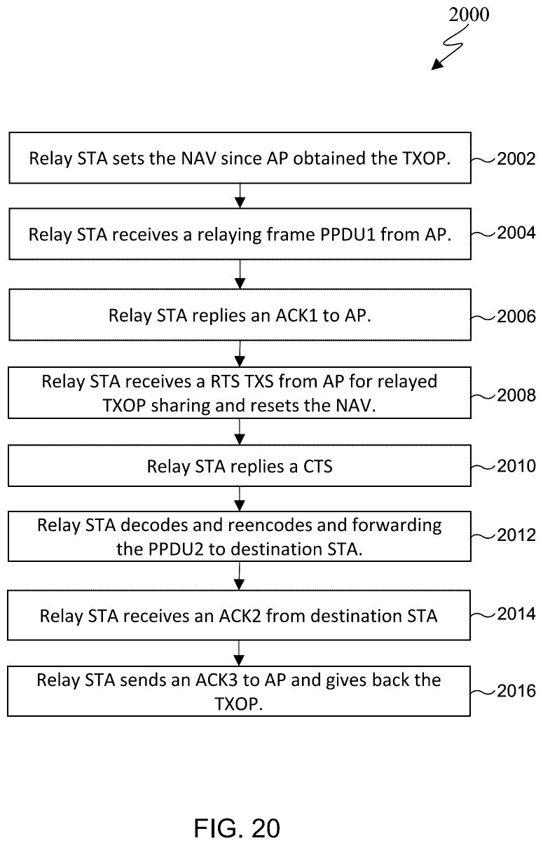

FIG. 20 illustrates an example flow diagram of a method 2000 performed by a relay STA for relay transmission in DL according to embodiments of the present disclosure. The embodiment of the method 2000 performed by a relay STA for relay transmission in DL shown in FIG. 19 is for illustration only. Other embodiments of the method 2000 performed by a relay STA for relay transmission in DL could be used without departing from the scope of this disclosure.

As illustrated in FIG. 20, the method 2000 begins at step 2002, where the relay STA sets the NAV since the AP obtained the TXOP. At step 2004, the relay STA receives a relaying frame PPDU1 from the AP. At step 2006, the relay STA replies to the AP with an ACK1. At step 2008, the relay STA receives an RTS TXS from the AP for relayed TXOP sharing and resets the NAV. At step 2010, the relay STA replies with a CTS. At step 2012, the relay STA decodes, reencodes, and forwarding the PPDU2 to the destination STA. At step 2014, the relay STA receives an ACK2 from the destination STA. At step 2016, the relay STA sends an ACK3 to the AP and gives back the TXOP.

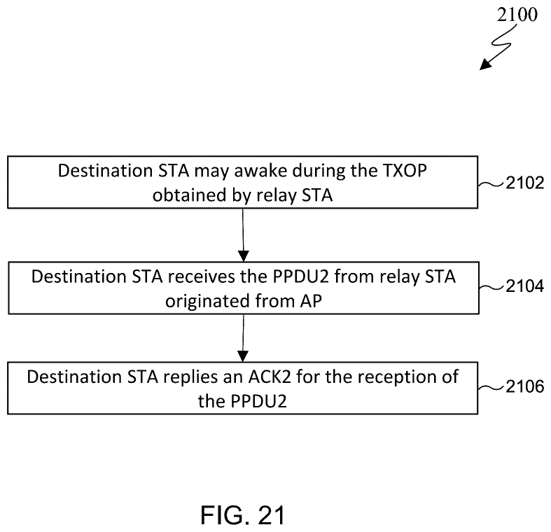

FIG. 21 illustrates an example flow diagram of a method 2100 performed by a destination STA for relay transmission in DL according to embodiments of the present disclosure. The embodiment of the method 2100 performed by a destination STA for relay transmission in DL shown in FIG. 21 is for illustration only. Other embodiments of the method 2100 performed by a destination STA for relay transmission in DL could be used without departing from the scope of this disclosure.

As illustrated in FIG. 21, the method 2100 begins at step 2102, where the destination STA may awake during the TXOP obtained by the relay STA. At step 2104, the destination STA receives the PPDU2 from the relay STA originated from the AP. At step 2106, the relay STA replies with an ACK2 for the reception of the PPDU2.

According to one embodiment, RTS/CTS protection can also be considered in the second hop. The relayed frame and other possible fields listed in Table. 1.1 could be considered in the Frame Control Field.

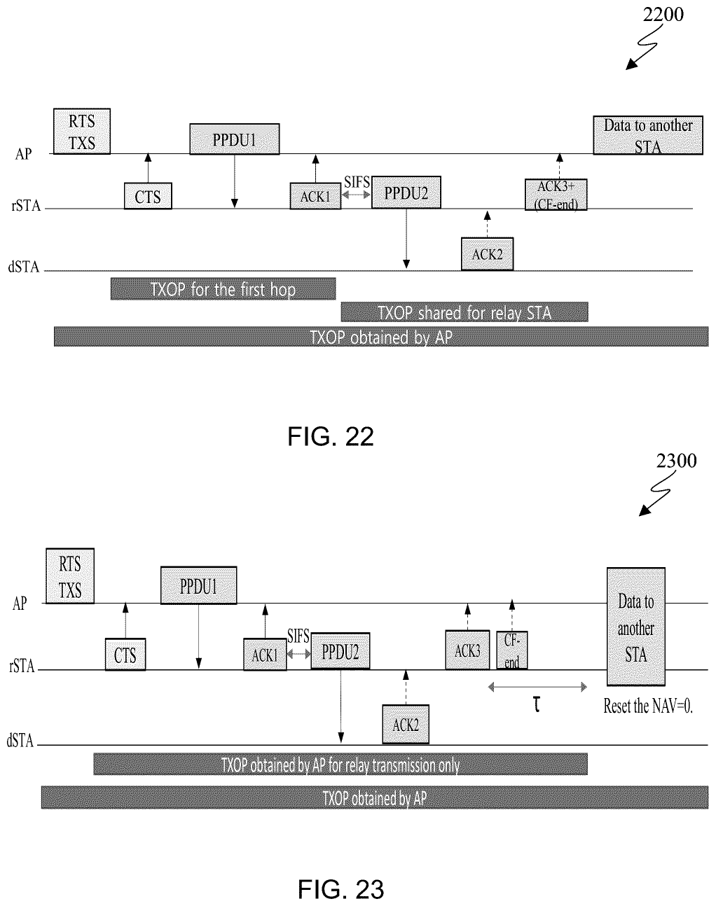

FIG. 22 illustrates an example of TXOP sharing for first and second hops 2200 according to embodiments of the present disclosure. The embodiment of the example of TXOP sharing for first and second hops 2200 shown in FIG. 22 is for illustration only. Other embodiments of the example of TXOP sharing for first and second hops 2200 could be used without departing from the scope of this disclosure.

According to one embodiment, the MU-RTS TXS can also be extended for both hops, which is shown in FIG. 22. It is worth noting that the current RTS TXS in 11be does not allow the DL PPDU from the AP to the rSTA. This is because the current RTS TXS only shares the TXOP to relay STA for the relay STA to use either UL or P2P. Therefore, some modification should be considered, for example, PPDU1 may be enabled during the RTS TXS.

The starting time of the TXOP sharing may be after the first hop transmission, thus a Timestamp field may be needed in the frame. A timestamp field in RTS TXS indicates the starting time of the second hop or the end of the first hop. Therefore, the TXOP holder is handover from the AP after the timestamp to the relay STA. Similar to other embodiments described herein, the modification of the RTS TXS can be made according to Table 1.2. The AP may indicate the relayed TXOP in the Frame Control Filed or the Common Info Field. Therefore, for relayed TXOP purpose, the AP could transmit the DL PPDU1 first in the first portion of the TXOP, and then the relay STA takes over the TXOP for relaying frames or starts its TXOP after it acknowledge the reception of PPDU1. This new type of triggered TXOP sharing mode 3 (for example) can be indicated in the Common Info Field. In addition, the User Info List may also need to consider both the relay STA and the destination STA. The address for each data frame PPDU may consider the four-address MAC header. The duration of this case can be estimated as MaxPPDUlength*2+CTS+5 or 6 SIF+2 or 3 ACKs.

According to another embodiment, the RTS TXS frame may include multiple TXOP slots indicating for each hop, and indicates the duration for each hop. The order information, the address, etc., is defined in the RTS TXS frame, an example of the information items is shown in Table 1.2. In the example illustrated in FIG. 22, two durations are estimated in the trigger frame and assigned for each hop.

TABLE 1.2
Information items may be considered in RTS TXS trigger frame

| Information items | Description |
|---|---|
| Timestamp | Indicate a starting time for the second hop. |
| Number of hops | Indicate the number of hops in the relay |
| | transmission. |
| First hop duration | Indicate the first hop's duration |
| First hop TXOP | Indicate the TXOP holder of the first hop |
| holder | |
| Second hop duration | Indicate the second hop's duration |
| Second hop TXOP | Indicate the TXOP holder of the second hop |
| holder | |

The design of ACK3 can be considered. The motivation of having ACK3 is to directly acknowledge the whole relay transmission is complete to the transmitter. The STA in 11ah will set an ACKTimeout to detect a PPDU that may acknowledge the reception of the MPDU, however, this could be spontaneous. The UHR ACK may have two functionalities. First, it acknowledges go the AP that the second-hop transmission is successful. Additionally, it may also return the TXOP back to the AP. According to one embodiment, ACK2 can just be a relayed ACK frame, and the rSTA reencodes the ACK2 as ACK3 and forwards it to the AP. The frame control field can indicate the frame is a relayed frame, so that the rSTA will forward the ACK to the AP. This relayed ACK is not falling into any ACK policy in the current spec. Thus, Table 2 shows the relayed ACK for relay transmission.

TABLE 2
ACK policy indication for relayed ACK

| Ack policy | Indicator | Meaning |
|---|---|---|
| Relayed | 11 | ACK is continuous relayed. For example, from |
| ACK | | destination STA to relay STA and then from |
| | | relay STA to transmitter. |

According to one embodiment, when the transmission ends ahead of time, the ACK3 may have the responsibility to return the TXOP back to the AP. The ACK3 then can be a CF-end frame which returns the TXOP back to the AP as a confirmation of the reception.

FIG. 23 illustrates an example DL TXOP returning and utilization of CF-end 2300 according to embodiments of the present disclosure. The embodiment of the example DL TXOP returning and utilization of CF-end 2300 shown in FIG. 23 is for illustration only. Other embodiments of the example DL TXOP returning and utilization of CF-end 2300 could be used without departing from the scope of this disclosure.

According to one embodiment, when the transmission ends ahead of time, for example, the PPDU2 can be transmitted with a high MCS compared with the AP's expectation, and the duration of the time τ is greater enough to transmit more than one CF-end, the relay STA may have the responsibility to return the TXOP back to the AP, as shown in FIG. 23. The ACK3 then can just be a CF-end frame which returns the TXOP back to the AP as a confirmation of the reception. In addition, if the τ is smaller than a CF-end with one SIFS time, it is ok to ignore the rest of the time.

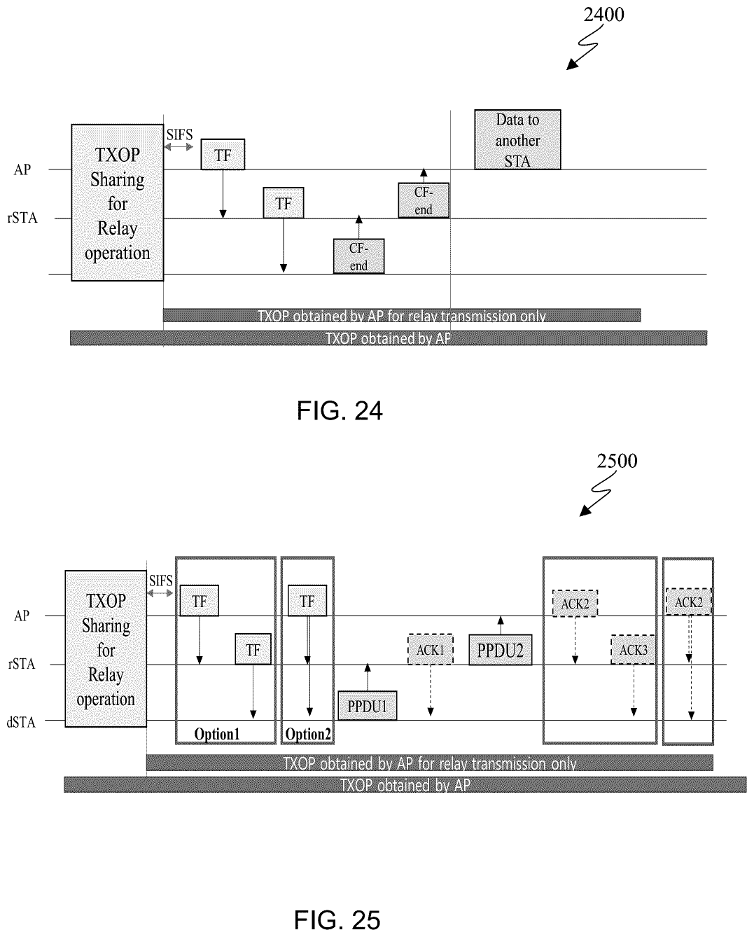

FIG. 24 illustrates an example UL TXOP returning with CF-end forwarding 2400 according to embodiments of the present disclosure. The embodiment of the example UL TXOP returning with CF-end forwarding 2400 shown in FIG. 24 is for illustration only. Other embodiments of the example UL TXOP returning with CF-end forwarding 2400 could be used without departing from the scope of this disclosure.

In the UL case, after the AP triggers the relay STA and the destination STA, the destination STA may not have any traffic in its buffer and thus would return the TXOP. Thus, a TXOP returning with CF-end forwarding is needed, an example is shown in FIG. 23.

The destination STA will generate the CF-end with relayed requirement. To enable the relayed CF-end frame, an information field such as Relay Enabling Field can be included in the Frame Control Field of the CF-end.

FIG. 25 illustrates an example of TXOP sharing for UL 2500 according to embodiments of the present disclosure. The embodiment of the example of TXOP sharing for UL 2500 shown in FIG. 25 is for illustration only. Other embodiments of the example of TXOP sharing for UL 2500 could be used without departing from the scope of this disclosure.

According to one embodiment, if the destination STA is out of the range of AP's coverage, the trigger frame for UL transmission needs to be relayed, as shown in FIG. 25, Option 1. The trigger frame is a relaying-frame from the AP to the relay STA, and then from the relay STA to the destination STA. A relayed information, shown in Table. 3, can be indicated in the Frame Control Field of the trigger frame, to indicate its utilization of relaying this frame. After receiving the trigger frame from the AP, the relay STA will wait until the PPDU1 is received by the destination STA. The duration can be indicated in the Duration fields of both trigger frames. The RA, TA, SA, and DA may also need to be indicated so that the relay STA will be notified that it should not transmit any data after transmitting the second TF.

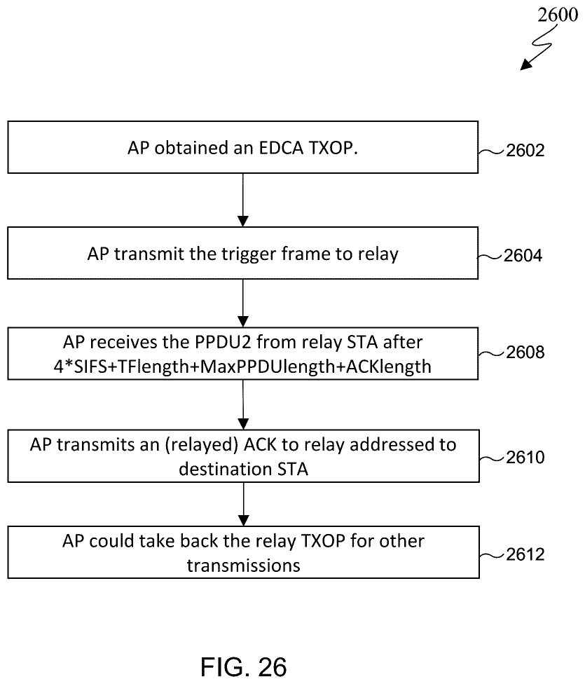

FIG. 26 illustrates an example flow diagram of a method 2600 performed by an AP for UL transmission with Option 1 according to embodiments of the present disclosure. The embodiment of the method 2600 performed by an AP for UL transmission with Option 1 shown in FIG. 26 is for illustration only. Other embodiments of the method 2600 performed by an AP for UL transmission with Option 1 could be used without departing from the scope of this disclosure.

As illustrated in FIG. 26, the method 2600 begins at step 2602, where the AP obtains an EDCA TXOP. At step 2604, the AP transmits the trigger frame to the relay STA. At step 2606, the AP receives the PPDU2 from the relay STA after 4*SIFS+TFlength+MaxPPDUlength+ACKlength. At step 2608, the AP transmits an (relayed) ACK to relay addressed to the destination STA. At step 2610, the AP may take back the relay TXOP for other transmissions.

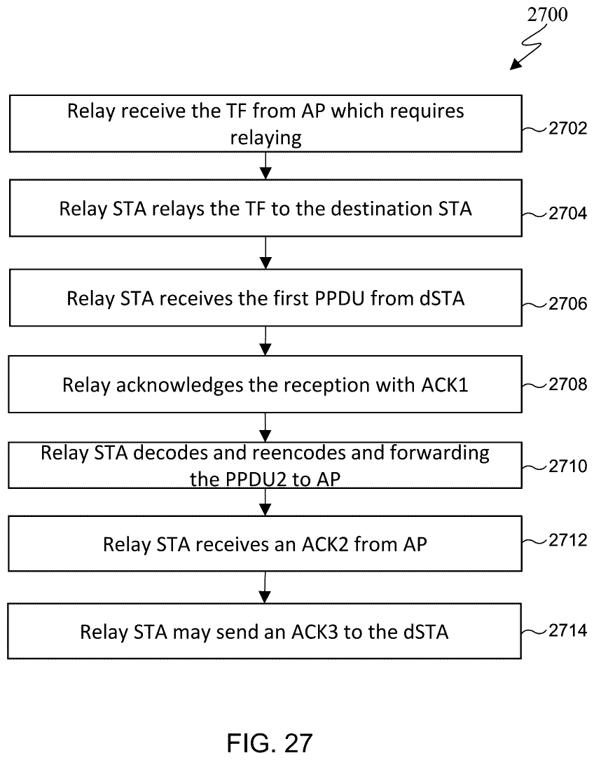

FIG. 27 illustrates an example flow diagram of a method 2700 performed by a relay STA for UL transmission with Option 1 according to embodiments of the present disclosure. The embodiment of the method 2700 performed by a relay STA for UL transmission with Option 1 shown in FIG. 27 is for illustration only. Other embodiments of the method 2700 performed by a relay STA for UL transmission with Option 1 could be used without departing from the scope of this disclosure.

As illustrated in FIG. 27, the method 2700 begins at step 2702, where the relay STA receives the TF from the AP which requires relaying. At step 2704, the relay STA relays the TF to the destination STA. At step 2706, the relay STA receives the first PPDU from the destination STA. At step 2708, the relay STA acknowledges the reception of the first PPDU with an ACK1. At step 2710, the relay STA decodes, reencodes, and forwards the PPDU2 to the AP. At step 2712, the relay STA receives an ACK2 from the AP. At step 2714, the relay stay may send an ACK3 to the destination STA.

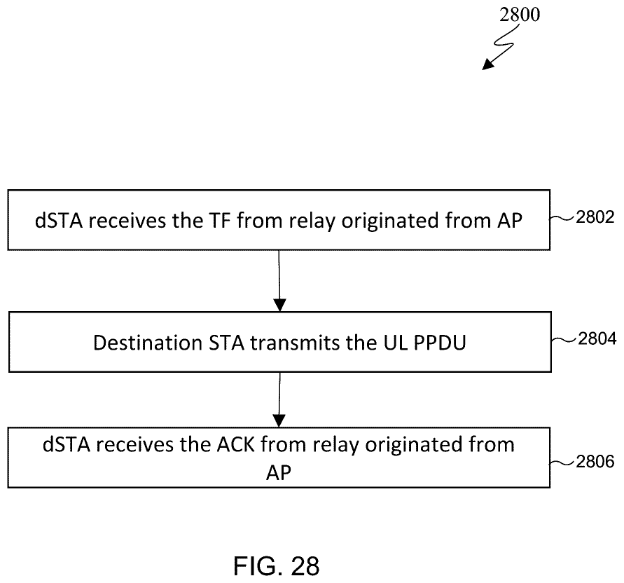

FIG. 28 illustrates an example flow diagram of a method 2800 performed by a destination STA for UL transmission with Option 1 according to embodiments of the present disclosure. The embodiment of the method 2800 performed by a destination STA for UL transmission with Option 1 shown in FIG. 28 is for illustration only. Other embodiments of the method 2800 performed by a destination STA for UL transmission with Option 1 could be used without departing from the scope of this disclosure.

As illustrated in FIG. 28, the method 2800 begins at step 2802, where the destination STA receives the TF from the relay originated from the AP. At step 2804, the destination STA transmits the UL PPDU. At step 2806, the destination STA receives an ACK from the relay originated from the AP.

TABLE 3
Information items for enabling UHR relay
capabilities in UL trigger frame

| Information | | |
|---|---|---|
| items | Description | Encoding |
| Relay | Indicate that if the STA is | Set to 1 if an AP or a non- |
| usability | capable to use frame-relaying | AP STA (destination STA |
| | through a UHR relay STA. | which may need relay |
| | | assistance) is able to use |
| | | relay STA. |
| Address | Indicates the address of the | Can be another field to |
| Extension | source STA and destination | indicates. |
| | STA. | |

In one embodiment, if the destination STA is within the range of the AP's coverage, the trigger frame for UL transmission can be heard by both the relay STA and the destination STA, as shown in FIG. 25, Option 2. The trigger frame is not a relaying-frame. Thus, the relay usability in Table 3. may be set to zero in the UL trigger frame for not enabling the relayed trigger frame.

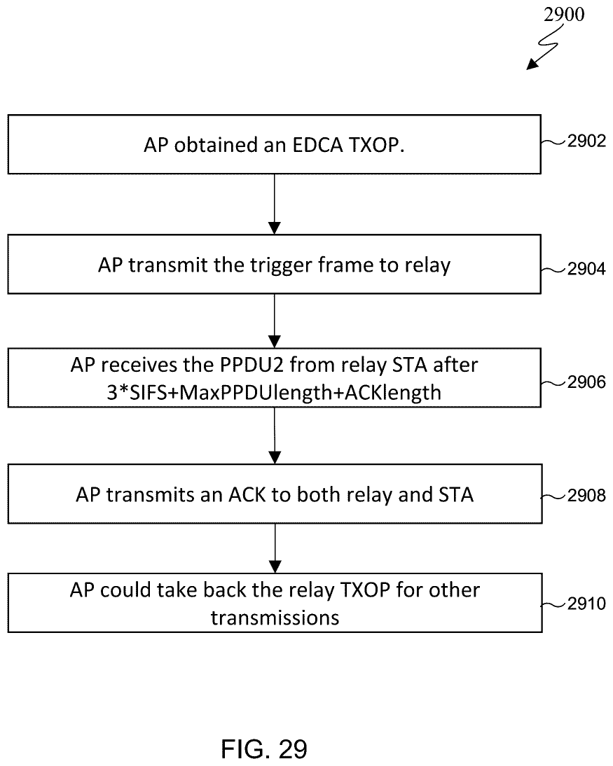

FIG. 29 illustrates an example flow diagram of a method 2900 performed by an AP for UL transmission with Option 2 according to embodiments of the present disclosure. The embodiment of the method 2900 performed by an AP for UL transmission with Option 2 shown in FIG. 29 is for illustration only. Other embodiments of the method 2900 performed by an AP for UL transmission with Option 2 could be used without departing from the scope of this disclosure.

As illustrated in FIG. 29, the method 2900 begins at step 2902, where the AP obtains an EDCA TXOP. At step 2904, the AP transmits the trigger frame to the relay STA. At step 2906, the AP receives the PPDU2 from the relay STA after 3*SIFS+MaxPPDUlength+ACKlength. At step 2908, the AP transmits an ACK to both the relay STA and the destination STA. At step 2910, the AP may take back the relay TXOP for other transmissions.

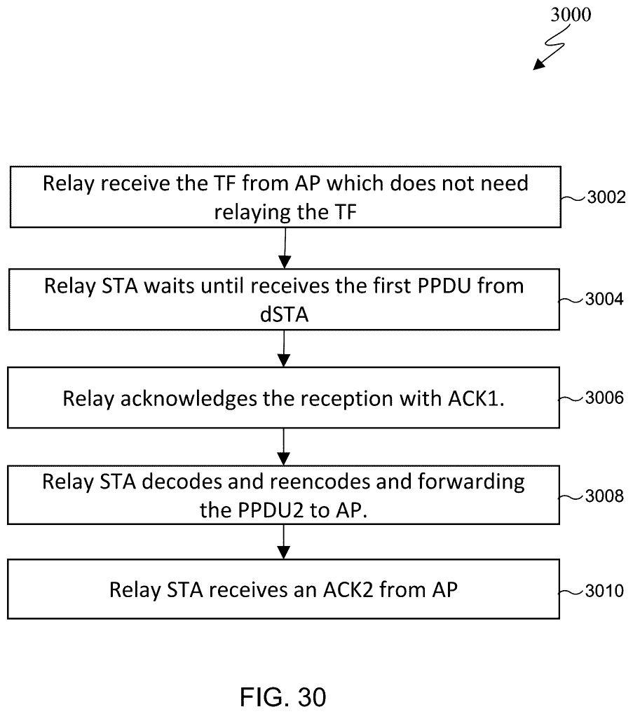

FIG. 30 illustrates an example flow diagram of a method 3000 performed by a relay STA for UL transmission with Option 2 according to embodiments of the present disclosure. The embodiment of the method 3000 performed by a relay STA for UL transmission with Option 2 shown in FIG. 30 is for illustration only. Other embodiments of the method 3000 performed by a relay STA for UL transmission with Option 2 could be used without departing from the scope of this disclosure.

As illustrated in FIG. 30, the method 3000 begins at step 3002, where the relay STA receives the TF from the AP which does not need relaying the TF. At step 3004, the relay STA waits until it receives the first PPDU from the destination STA. At step 3006, the relay STA acknowledges the reception of the first PPDU with an ACK1. At step 3008, the relay STA decodes, reencodes, and forwards the PPDU2 to the AP. At step 3010, the relay STA receives an ACK2 from the AP.

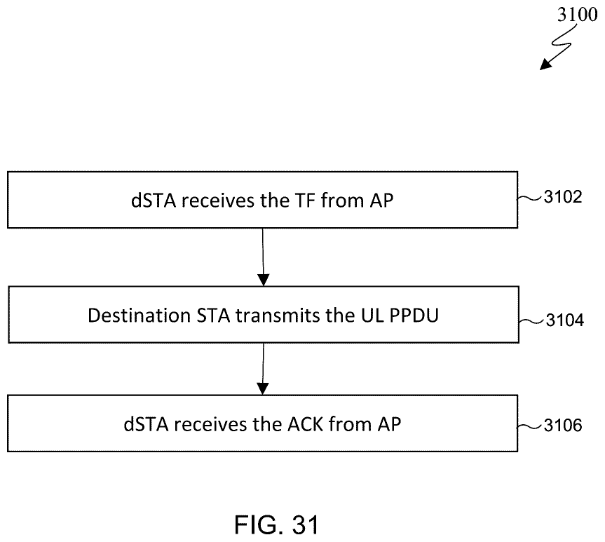

FIG. 31 illustrates an example flow diagram of a method 3100 performed by a destination STA for UL transmission with Option 2 according to embodiments of the present disclosure. The embodiment of the method 3100 performed by a destination STA for UL transmission with Option 2 shown in FIG. 31 is for illustration only. Other embodiments of the method 3100 performed by a destination STA for UL transmission with Option 2 could be used without departing from the scope of this disclosure.

As illustrated in FIG. 31, the method 3100 begins at step 3102, where the destination STA receives the TF from the AP. At step 3104, the destination STA transmits the UL PPDU. At step 3106, the destination STA receives an ACK from the AP.

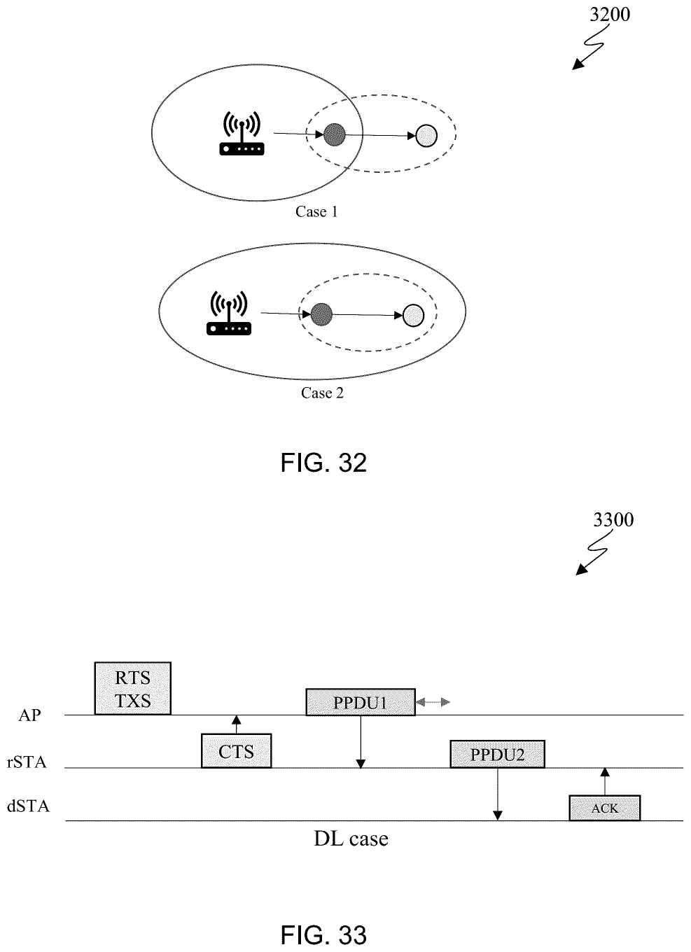

FIG. 32 illustrates example scenarios of Option 1 and Option 2 3200 according to embodiments of the present disclosure. The embodiment of the example scenarios of Option 1 and Option 2 3200 shown in FIG. 32 is for illustration only. Other embodiments of the example scenarios of Option 1 and Option 2 3200 could be used without departing from the scope of this disclosure.

As discussed above, Option 1 may be needed if the STA is out of the coverage area of the AP, as shown in Case 1 of FIG. 32, while Option 2 may be considered if the destination STA is within the coverage of AP, as shown in Case 2 of FIG. 32. The AP may decide the option based on the RSSI between the AP and the destination STA. The relay STA can also report the need of relaying control or management frames if the RSSI of the AP and the relay is weak.

FIG. 33 illustrates an example of an implicit ACK in a DL scenario 3300 according to embodiments of the present disclosure. The embodiment of the example of an implicit ACK in a DL scenario 3300 shown in FIG. 33 is for illustration only. Other embodiments of the example of an implicit ACK in a DL scenario 3300 could be used without departing from the scope of this disclosure.

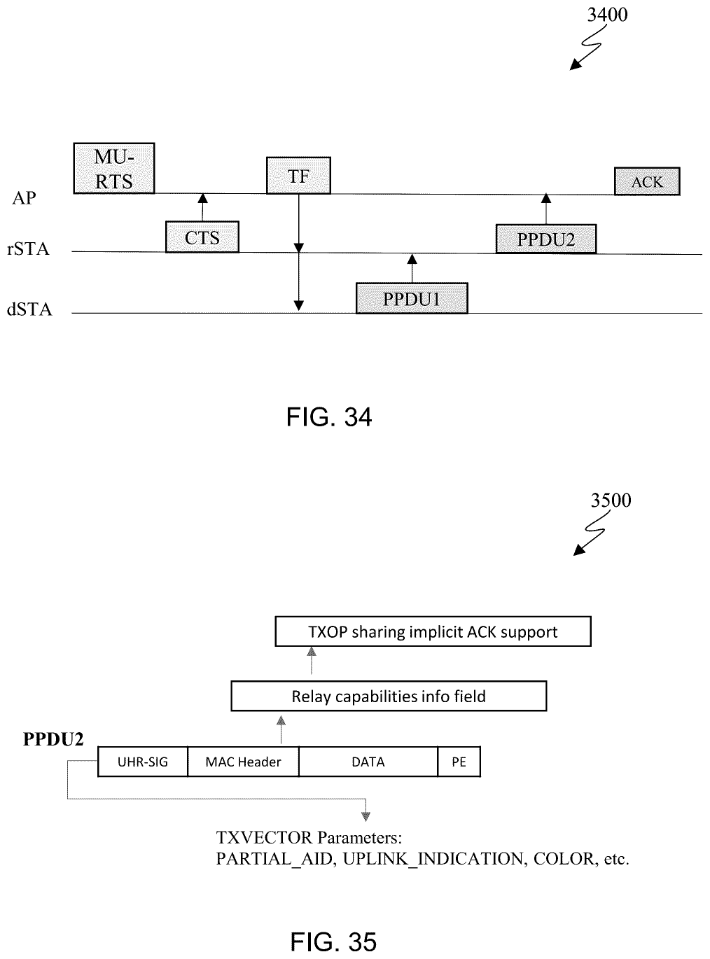

FIG. 34 illustrates an example of an implicit ACK in a UL scenario 3400 according to embodiments of the present disclosure. The embodiment of the example of an implicit ACK in a UL scenario 3400 shown in FIG. 34 is for illustration only. Other embodiments of the example of an implicit ACK in a UL scenario 3400 could be used without departing from the scope of this disclosure.

To optimize the ACK mechanism in relay transmission, the ACK can be simplified among the nodes. For example, the DL and UL cases with simplified ACK are illustrated in FIG. 33 and in FIG. 34, respectively.

FIG. 35 illustrates an example TXOP sharing an implicit ACK support field 3500 according to embodiments of the present disclosure. The embodiment of the example TXOP sharing an implicit ACK support field 3500 shown in FIG. 35 is for illustration only. Other embodiments of the example TXOP sharing an implicit ACK support field 3500 could be used without departing from the scope of this disclosure.

A relay STA that support of TXOP sharing with implicit ACK may need to use a TXOP sharing implicit ack support field which could be embedded in the relay capabilities info field of the MAC header. If implementing the implicit ACK is true, the TXOP sharing implicit ACK support should be set to 1, Otherwise, the subfield should be set to 0. An example is shown in FIG. 35.

When a relay station forwards a received packet to a destination station, the destination station's PAID may be included in the PAID subfield. If the source station knows the destination station's PAID (via association, probe, response frame, etc.), the source station can identify that the following packet is the relay station's forwarding packet, by checking the PAID subfield of the following packet's SIG field without decoding the data payload part. The PAID is a function of the BSSID and the AID of the destination.

According to one embodiment, enabling the Partial AID (PAID) in relay transmission in UHR for implicit ACK indication can be considered. The PAID in the PPDU (e.g., PPDU2 in FIG. 34 and FIG. 35) generated by relay STA may indicate the BSSID of the AP's BSS and the AID of the destination STA in the PHY header. The PPDU2 may contain a Partial AID, UPLINK_INDICATION, and COLOR, etc., in their PHY header so that the originator can detect the field in PHY SIG but without decoding the payload part and thus without needing an ACK from the relay STA.
For DL, the AP may determine the PARTIAL_AID of the relay STA using the BSSID of the UHR AP's BSS and the AID of the next hop non-AP STA to be able to use the implicit Ack procedure.
For UL, the non-AP STA may determine the PARTIAL_AID from the PHY SIG field of relay STA using the AP's BSSID and COLOR values to be able to use the implicit Ack procedure.

The source may be aware of the PAID information during the discovery, setup, and/or (re) association procedure.

According to one embodiment, in the PPDU2, a reception indication bit can be considered in the UHR-SIG to indicate if the hop is successful or not. For example, a hop indication bit with value X (HopInd=X) transmitted by the AP in DL starts the transmission. If the relay receives the PPDU1 and successfully transmits the PPDU2, the relay STA may indicate HopInd=1, and the AP will detect the bit and knows the second hop is transmitted. Otherwise, the relay may indicate HopInd=0 for any error such as not receiving the PPDU1. In addition, the UHR-SIG for PPDU2 may indicate a multicast transmission.

According to one embodiment, the frame with CF-ACK+DATA can also be considered. The DATA is relayed Data from AP to the destination STA via the relay STA. The CF-ACK is for the AP. This is a mechanism of PCF or HCCA.

According to one embodiment, a frequency domain ACK can also be considered. The ACK may be transmitted in another frequency band or links in MLO.

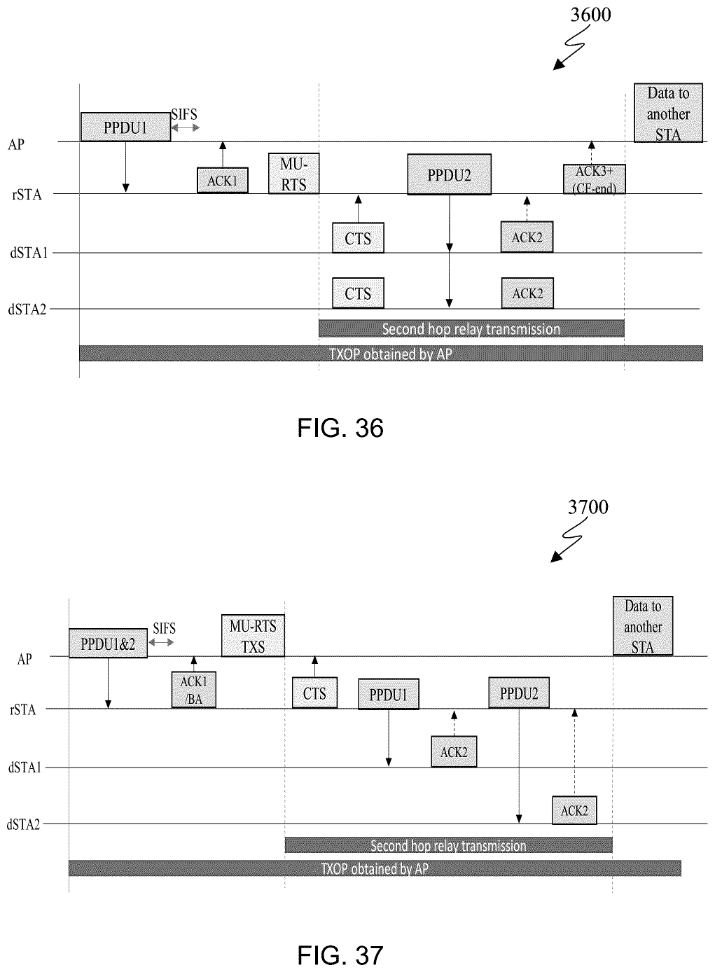

FIG. 36 illustrates an example TXOP sharing for a second hop with multiple destination STAs 3600 according to embodiments of the present disclosure. The embodiment of the example TXOP sharing for a second hop with multiple destination STAs 3600 shown in FIG. 36 is for illustration only. Other embodiments of the example TXOP sharing for a second hop with multiple destination STAs 3600 could be used without departing from the scope of this disclosure.

According to one embodiment, the MU-RTS/CTS can also be utilized for multiple destination STAs through the relay STA. The AP initiates the relay transmission with two different PPDUs, e.g., PPDU1 intended for dSTA1 and PPDU2 intended for dSTA2. After receiving an ACK from the relay STA, the relay STA can protect the second hop transmission by transmission of an MU-RTS/CTS frame, as shown in FIG. 36, the MU-RTS is allowed in the AP, and may be limited to the STA, then the relay STA can be a soft AP or have a relay AP imbedded, or with an AP entity, or the limitation in UHR may be relaxed.

FIG. 37 illustrates an example MU-RTS TXOP TXS for second hop with multiple destination STAs 3700 according to embodiments of the present disclosure. The embodiment of the example MU-RTS TXOP TXS for second hop with multiple destination STAs 3700 shown in FIG. 37 is for illustration only. Other embodiments of the example MU-RTS TXOP TXS for second hop with multiple destination STAs 3700 could be used without departing from the scope of this disclosure.

According to one embodiment, the MU-RTS TXS/CTS can also be considered for multiple destination STAs. The MU-RTS TXS is an extension of the RTS TXS/CTS mode 2 in current 11be. As illustrated in FIG. 37, once the AP transmits the PPDU1 and PPDU2 for both dSTA1 and dSTA2, the AP may start the MU-RTS TXS. Then the relay STA can perform the transmission in which the relay STA is the TXOP holder. The information of the multiple destination STAs can be included in the User Info Field of the RTS TXS trigger frame. The number of the destination STAs can be included in the trigger frame as well.

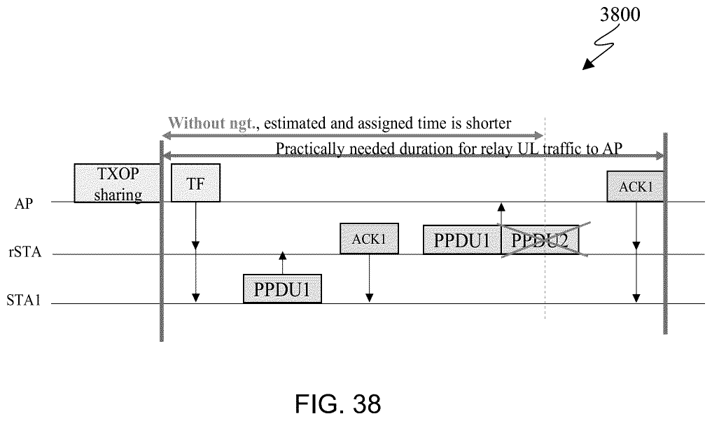

FIG. 38 illustrates an example of TXOP sharing in relay transmission with multi-traffic 3800 according to embodiments of the present disclosure. The embodiment of the example of TXOP sharing in relay transmission with multi-traffic 3800 shown in FIG. 38 is for illustration only. Other embodiments of the example of TXOP sharing in relay transmission with multi-traffic 3800 could be used without departing from the scope of this disclosure.

As described herein with respect to FIGS. 15A and 15B, a TXOP sharing procedure can be considered. However, the situation described therein only considers the relay traffic, that is, the data is a relayed-frame only from source to destination via relay. Various embodiments of the present disclosure recognize that in the next generation of Wi-Fi with coordinated networks, the relay STA may not only have the relay functionality but perform as a normal STA as well. In such case, the source could have a relayed frame to destination via relay, and may also involve the traffic between source and relay, and/or the traffic between relay to destinations. The TXOP sharing for such case is not clear. For example, STA1 may have an uplink transmission of PPDU1 to a destination AP via relay, and at the same time, the relay STA may take the opportunity to perform an uplink traffic from itself to the AP, as seen in FIG. 38. If the AP is not aware of the transmission of PPDU2, the AP may estimate and assign a shorter TXOP than that in practice, which will prevent the relay transmission with multi-traffic from happening.

Accordingly, various embodiments of the present disclosure provide mechanisms where the relay STA may not only have the relay functionality but perform as a normal STA as well.

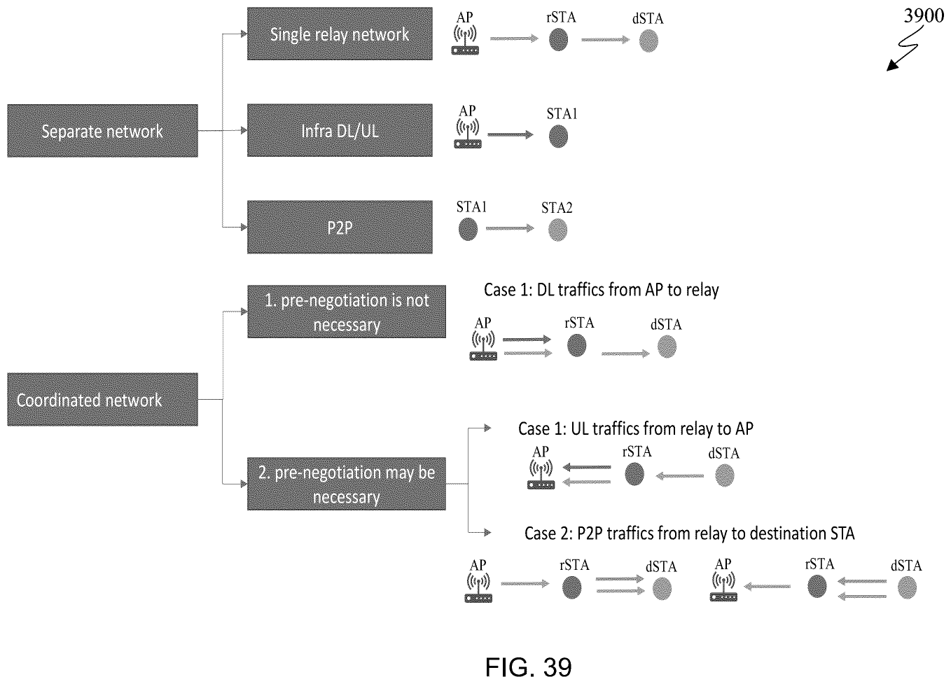

FIG. 39 illustrates an example of the categories of networks 3900 according to embodiments of the present disclosure. The embodiment of the example of the categories of networks 3900 shown in FIG. 39 is for illustration only. Other embodiments of the example of the categories of networks 3900 could be used without departing from the scope of this disclosure.

A separate network may contain only the infrastructure uplink and downlink traffic, non-IEEE technologies for P2P such as Wi-Fi direct, Wi-Fi aware, etc., and single relay networks, in which the relay STA in a single relay network only performs the relay functionality for forwarding the traffic between source and destination. A coordinated relay network may include both of the relay traffic and infrastructure and/or P2P traffic. Examples of different networks is shown in FIG. 39. Within the category of coordinated network, scenario 1 is considered as an unnecessary pre-negotiation case, where there are the DL traffic from the AP to the relay as well as the relay transmission. This may not need pre-negotiation since the AP may schedule enough time for both traffic. However, in the scenario 2, both case 1 for UL traffic from the relay to the AP, and case 2 for P2P traffic from the relay to the destination STA may need additional pre-negotiation in case the schedule problem happens in FIG. 38.

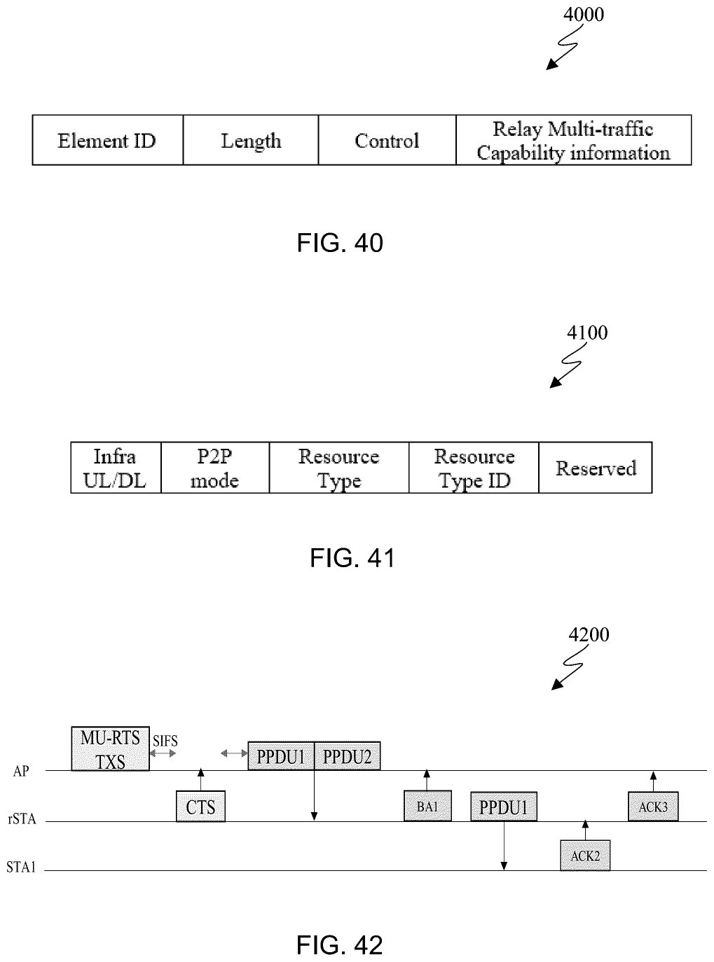

FIG. 40 illustrates an example relay multi-traffic capabilities information element 4000 according to embodiments of the present disclosure. The embodiment of the example relay multi-traffic capabilities information element 4000 shown in FIG. 40 is for illustration only. Other embodiments of the example relay multi-traffic capabilities information element 4000 could be used without departing from the scope of this disclosure.

According to one embodiment, the multi-traffic may need to be indicated in an element. An example of the Relay Multi-traffic Element is shown in FIG. 40. A source, relay, and destination may include the element in the Discovery, Setup, and (re)association frames, etc., for frame exchange.

FIG. 41 illustrates an example relay capabilities information field format 4100 according to embodiments of the present disclosure. The embodiment of the example relay capabilities information field format 4100 shown in FIG. 41 is for illustration only. Other embodiments of the example relay capabilities information field format 4100 could be used without departing from the scope of this disclosure.

The Relay Multi-Traffic Capability Information Field is illustrated in FIG. 41. This field is to indicate the information for multi-traffic in relay transmission.

The Infra UL/DL subfield indicates the additional traffic other than relay traffic is for infrastructure UL or DL traffic between the AP and the relay STA. It may be set to 1 for infrastructure UL traffic, and set to 0 for DL traffic.

The P2P mode subfield indicates the additional traffic other than relay traffic is for P2P traffic between the relay STA and the destination STA. It may be set to 1 for the existing P2P traffic, and set to 0 if no P2P traffic is involved.

The Resource Type subfield indicates if the transmission happens via time multiplexing, or different frequency bands, or different link of the MLD. An example of the values could be: If the resource type is 0, the multi-traffic goes via the time domain, in which the PPDU are spliced and multiplexed together. If the resource type is 1, the traffic goes through different frequency bands. If the resource type is 2, the traffic goes through different links of the MLD. The way of integrating the PPDU, different RUs, and link IDs are denoted in the Resource Type ID subfield.

According to another embodiment, the multi-traffic can be directly labeled into different types/modes. For example, in Table 4, a Multi-traffic type field is listed, in which each type corresponds to one kind of multi-traffic.

TABLE 4
type of multi-traffic

| Type value | Description |
|---|---|
| 0 | Single relay transmission, only one relaying frame |
| | from source to destination via relay. |
| 1 | DL relay transmission with infra DL from AP to relay. |
| 2 | UL relay transmission with infra UL from relay to AP. |
| 3 | DL relay transmission with P2P from relay to destination. |
| 4 | UL relay transmission with P2P from destination to relay. |
| 5 | DL relay transmission with both infra DL from AP to |
| | relay and P2P from relay to destination. |
| 6 | UL relay transmission with both infra UL from relay to |
| | AP and P2P from destination to relay. |
| 7 | Reserved. |

FIG. 42 illustrates an example of TXOP sharing for relay transmission with multi-traffic: DL from the AP to the relay STA 4200 according to embodiments of the present disclosure. The embodiment of the example of TXOP sharing for relay transmission with multi-traffic: DL from the AP to the relay STA 4200 shown in FIG. 42 is for illustration only. Other embodiments of the example of TXOP sharing for relay transmission with multi-traffic: DL from the AP to the relay STA 4200 could be used without departing from the scope of this disclosure.

If the multi-traffic chooses the time resource, then the protection, e.g., relayed TXOP sharing, could be necessary for protecting the additional traffic. An example of the TXOP sharing for relay transmission with multi-traffic for the DL traffic from the AP to the relay STA is illustrated in FIG. 42.

The Multi-traffic element may need to be indicated in the trigger frame. The duration time in the Duration Field of MU-RTS TXS that AP may assign will need to consider the need for PPDU2.

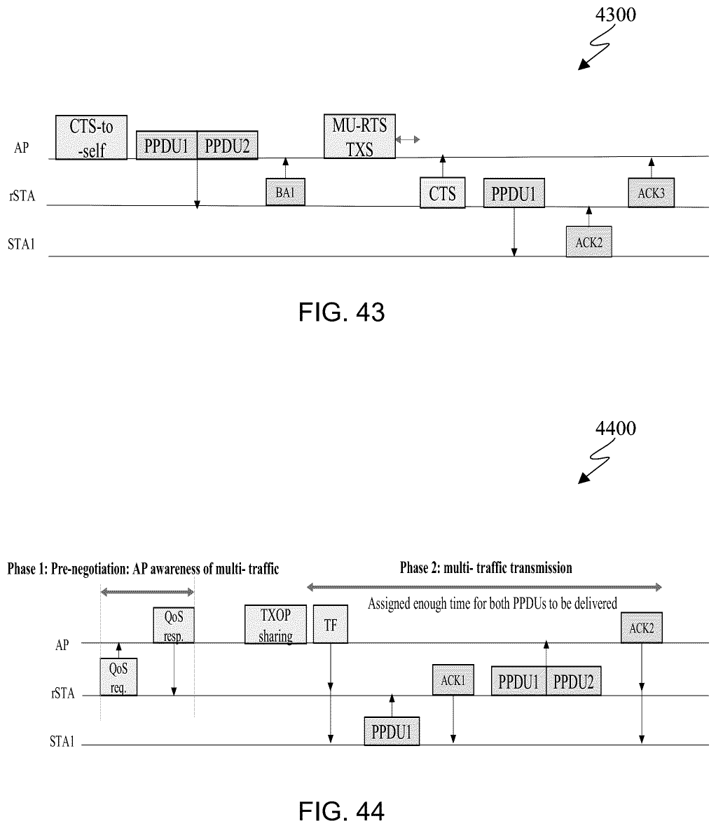

FIG. 43 illustrates another example of TXOP sharing for relay transmission with multi-traffic: DL from AP to the relay STA 4300 according to embodiments of the present disclosure. The embodiment of the example of TXOP sharing for relay transmission with multi-traffic: DL from the AP to the relay STA 4300 shown in FIG. 43 is for illustration only. Other embodiments of the example of TXOP sharing for relay transmission with multi-traffic: DL from the AP to the relay STA 4300 could be used without departing from the scope of this disclosure.

According to another embodiment, as illustrated in FIG. 43, the TXOP sharing may also protect the second hop using the MU-RTS TXS Mode 2. Once the relay STA is aware of the traffic that PPDU2 is for itself and then perform the PPDU1 as a relay transmission for the next hop only. The multi-traffic can be included in the CTS-to-self for protecting the multi-traffic.

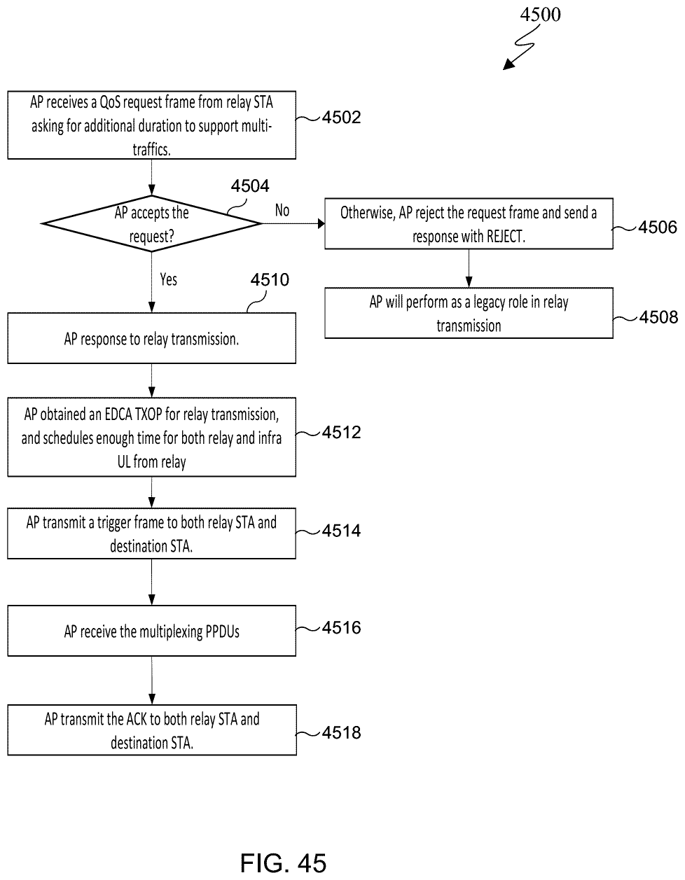

FIG. 44 illustrates another example of TXOP sharing for relay transmission with multi-traffic: DL from AP to the relay STA 4400 according to embodiments of the present disclosure. The embodiment of the example of TXOP sharing for relay transmission with multi-traffic: DL from the AP to the relay STA 4400 shown in FIG. 44 is for illustration only. Other embodiments of the example of TXOP sharing for relay transmission with multi-traffic: DL from the AP to the relay STA 4400 could be used without departing from the scope of this disclosure.

In one embodiment, the pre-negotiation may be needed as shown in FIG. 39 to resolve the problem of insufficient time assignment. Such a problem may happen in the case when there is infra UL traffic from the relay to the AP along the relay transmission. Since the AP may not be aware of the traffic from the relay to the AP along with the forwarding PPDU, it may be difficult to schedule a relayed TXOP with additional time. To solve this, the relay STA could announce the possible traffic ahead of time through the negotiation, and include the multi-traffic element in the (re)association, setup frames, etc., for such service support.

Two phases are considered as shown in FIG. 44. In Phase 1, pre-negotiation is considered in which the AP can be aware of the relay transmission with multi-traffic. In Phase 2, the relay transmission with multi-traffic is performed.

The negotiation happens between the relay STA and the source. When the relay transmission starts, the relay may inform the source about the multi-traffic requirement by transmitting a QoS Request Frame and may include the Multi-traffic Element. If the AP receives the Multi-traffic Element in the Request Frame from the relay STA successfully, and accepts the request, then the AP may consider scheduling a TXOP sharing trigger frame for the relay transmission with multi-traffic, where the duration field should last enough time for all traffic. During the allocated TXOP duration, the relay STA may not only forward the PPDU1 from the destination STA to the AP via the relay STA but also it may multiplex the infra UL traffic to the AP, i.e., the PPDU2 shown in FIG. 44.

The QoS/service request frame may include the multi-traffic element, and may also consider the following items, shown in Table 5.

TABLE 5
Information field in the request frame

| Information | | |
|---|---|---|
| field | Description | Encoding |
| Multi-traffic | This subfield indicates if the | A bit is set to 1 if the |
| indication | relay STA may have any | relay indicates the need |
| | requirement for multi-traffic | of the multi-traffic |
| | transmission along with the | transmission. Otherwise, |
| | relay transmission. | a bit is set to 0 |
| | | for no multi-traffic |
| | | transmission which is the |
| | | single relay transmission. |
| Multi-traffic | This subfield indicates if the | If disabled, set to 1; |
| disabled | multi-traffic function is | otherwise, set to 0. |
| | disabled by the relay in the | |
| | next service period. | |
| Buffer Status | This subfield indicates if there | Indicate if the buffer |
| for | is multi-traffic in the buffer | included any multi-traffic. |
| multi-traffic | of relay STA. The relay may | |
| | label the traffic that is not | |
| | for relaying purpose. | |
| Periodicity | This subfield indicates if the | The periodicity subfield |
| | multi-traffic is periodic or | is set to 1 for multiple |
| | aperiodic. | transmissions in the service |
| | | period. Otherwise, an |
| | | aperiodic multi-traffic |
| | | transmission is considered. |
| Duration of | This subfield indicates the | A value of the PPDU length |
| multi-traffic | time of the multi-traffic | depends on the practical |
| | that may need. | buffer status. |

In the QoS support response frame, the AP may indicate accept or reject the multi-traffic transmission in the frame.

After the AP obtains the multi-traffic information it may need to count and estimate the time in the Duration Field. The AP can add the additional time from the Duration of multi-traffic field with the PPDU for the relay transmission. In addition, the AP may calculate the duration by considering the PPDU with maximum length.

To tear down the multi-traffic functionality, a Multi-traffic Tear Down Frame is transmitted from the relay to the AP. The multi-traffic in relay transmission is terminated after transmitting or receiving the teardown frame.

According to another embodiment, the QoS element in one trigger frame can also be performed before the relay transmission. AP may transmit the BSRP trigger frame to pull the buffer report from the relay before schedule any TXOP sharing. In the buffer of the relay, it may need to indicate the purpose of the PPDU.

FIG. 45 illustrates an example flow diagram of a method 4500 performed by an AP for multi-traffic: UL from the relay to the AP according to embodiments of the present disclosure. The embodiment of the method 4500 performed by an AP for multi-traffic: UL from the relay to the AP shown in FIG. 45 is for illustration only. Other embodiments of the method 4500 performed by an AP for multi-traffic: UL from the relay to the AP could be used without departing from the scope of this disclosure.

As illustrated in FIG. 45, the method 4500 begins at step 4502, where the AP receives a QoS request frame from the relay STA asking for additional duration to support multi-traffic. At step 4504, a determination is made whether the AP accepts the request. If the AP does not accept the request, then at step 4506, the AP rejects the request frame and send a response with REJECT, and thereafter at step 4508, the AP may perform as a legacy role in relay transmission. If the AP accepts the request at step 4504, then at step 4510, the AP responds to the relay transmission. At step 4512, the AP obtains an EDCA TXOP for relay transmission, and schedules enough time for both relay and infra UL from the relay. At step 4514, the AP transmits a trigger frame to both the relay STA and the destination STA. At step 4516, the AP receives the multiplexing PPDUs. At step 4518, the AP transmits the ACK to both the relay STA and the destination STA.

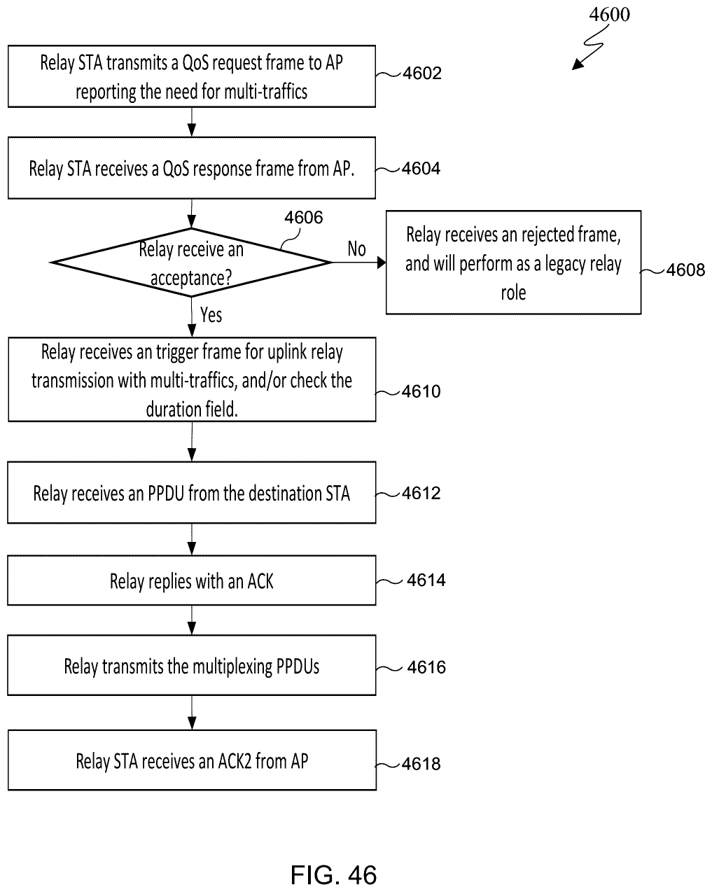

FIG. 46 illustrates an example flow diagram of a method 4600 performed by a relay STA for multi-traffic: UL from the relay to AP according to embodiments of the present disclosure. The embodiment of the method 4600 performed by a relay STA for multi-traffic: UL from the relay to the AP shown in FIG. 46 is for illustration only. Other embodiments of the method 4600 performed by a relay STA for multi-traffic: UL from the relay to the AP could be used without departing from the scope of this disclosure.

As illustrated in FIG. 46, the method 4600 begins at step 4602, where the relay STA transmits a QoS request frame to the AP reporting the need for multi-traffic. At step 4604, the relay STA receives a QoS response frame from the AP. At step 4606, a determination is made whether the relay stay receives an acceptance. If the relay stay does not receive an acceptance, then at step 4608, the relay stay receives a rejected frame, and may perform as a legacy relay role. If the relay stay does receive an acceptance, then at step 4610, the relay stay receives a trigger frame for uplink relay transmission with multi-traffic, and/or check the duration field. At step 4612, the relay STA receives a PPDU from the destination STA. At step 4614, the relay STA replies with an ACK. At step 4616, the relay STA transmits the multiplexing PPDUs. At step 4618, the relay STA receives an ACK2 from the AP.

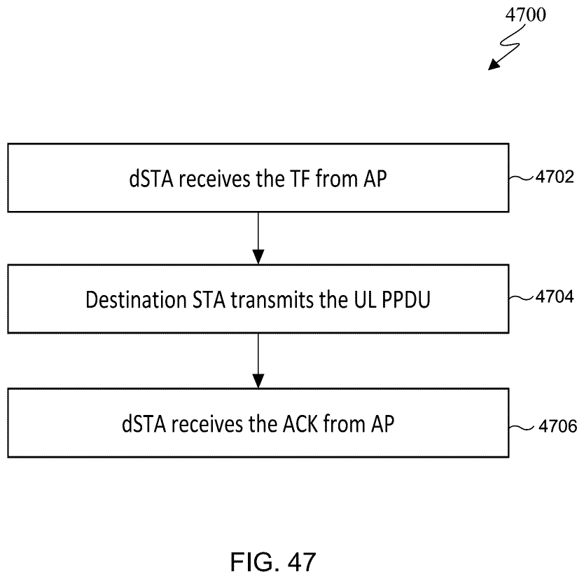

FIG. 47 illustrates an example flow diagram of a method 4700 performed by a destination STA for multi-traffic: UL from relay to AP according to embodiments of the present disclosure. The embodiment of the method 4700 performed by a destination STA for multi-traffic: UL from the relay to the AP shown in FIG. 47 is for illustration only. Other embodiments of the method 4700 performed by a destination STA for multi-traffic: UL from the relay to the AP could be used without departing from the scope of this disclosure.

As illustrated in FIG. 47, the method 4700 begins at step 4702, where the destination STA receives the TF from the AP. At step 4704, the destination STA transmits the UL PPDU. At step 4706, the destination STA receives an ACK from the AP.

The procedure for the destination STA may not be very different compared with a legacy STA. However, the destination STA may wait some more time to receive the final ACK from the AP. In order that the destination STA waits for more time until the AckTimeOut, it may also check the duration field in the trigger frame.

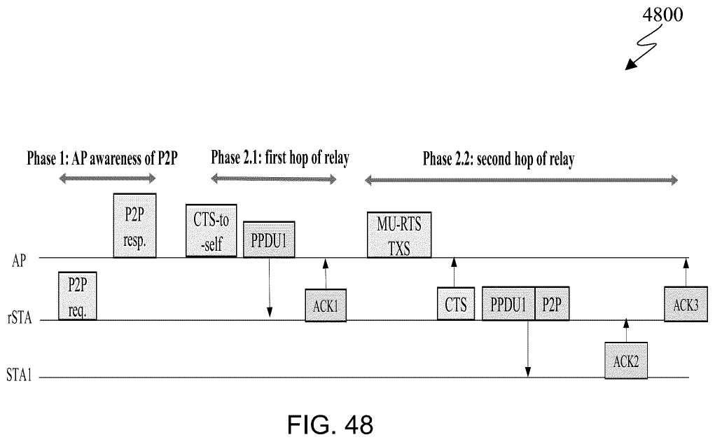

FIG. 48 illustrates an example of TXOP sharing for relay transmission with multi-traffic: DL P2P with request and response negotiation 4800 according to embodiments of the present disclosure. The embodiment of the example of TXOP sharing for relay transmission with multi-traffic: DL P2P with request and response negotiation 4800 shown in FIG. 48 is for illustration only. Other embodiments of the example of TXOP sharing for relay transmission with multi-traffic: DL P2P with request and response negotiation 4800 could be used without departing from the scope of this disclosure.

According to one embodiment, the DL and UL P2P may also consider using the service request and response frame to notify the AP about the multi-traffic (P2P) transmission. A DL P2P from relay to destination STA along with the relaying-frame is shown in FIG. 48.

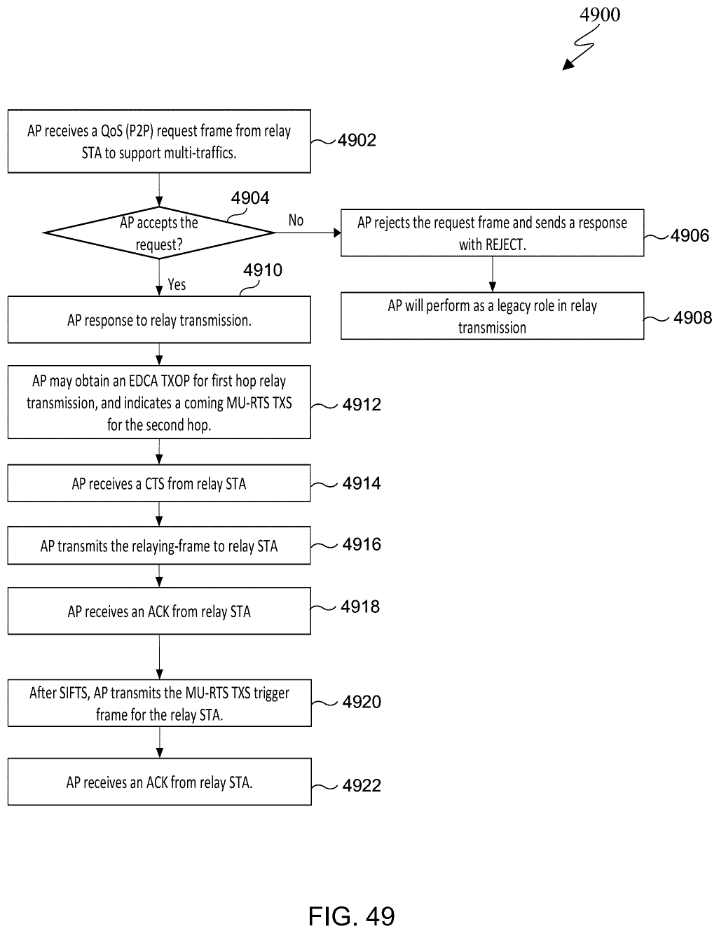

FIG. 49 illustrates an example flow diagram of a method 4900 performed by an AP for multi-traffic: P2P between the relay STA and the destination STA according to embodiments of the present disclosure. The embodiment of the method 4900 performed by an AP for multi-traffic: P2P between the relay STA and the destination STA shown in FIG. 49 is for illustration only. Other embodiments of the method 4900 performed by an AP for multi-traffic: P2P between the relay STA and the destination STA could be used without departing from the scope of this disclosure.

As illustrated in FIG. 49, the method 4900 begins at step 4902, where the AP receives a QoS (P2P) request frame from the relay STA to support multi-traffic. At step 4904, a determination is made whether the AP accepts the request. If the AP does not accept the request, then at step 4906, the AP rejects the request frame and sends a response with REJECT, and thereafter at step 4908, the AP may perform as a legacy role in relay transmission. If the AP accepts the request at step 4904, then at step 4910, the AP responds to the relay transmission. At step 4912, the AP obtains an EDCA TXOP for first hop relay transmission, and indicates a coming MU-RTS TXS for the second hop. At step 4914, the AP receives a CTS from the relay STA. At step 4916, the AP transmits the relaying-frame to relay STA. At step 4916, the AP receives an ACK from relay STA. At step 4918, the AP, after SIFTS, transmits the MU-RTS TXS trigger frame for the relay STA. At step 4920, the AP receives an ACK from the relay STA.

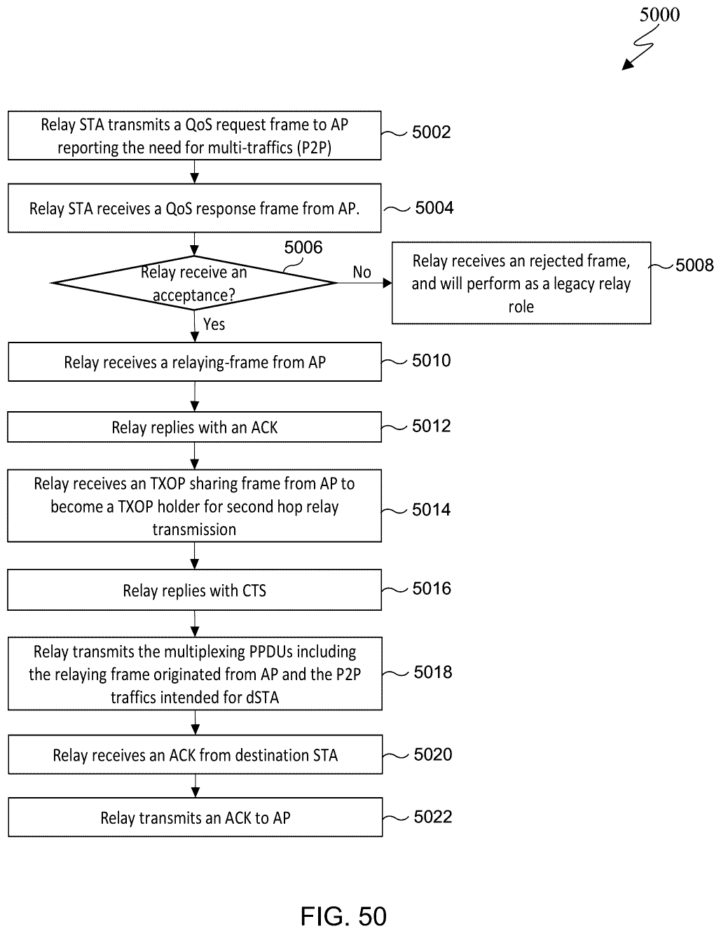

FIG. 50 illustrates an example flow diagram of a method 5000 performed by a relay STA for multi-traffic: P2P between the relay STA and the destination STA according to embodiments of the present disclosure. The embodiment of the method 5000 performed by a relay STA for multi-traffic: P2P between the relay STA and the destination STA shown in FIG. 50 is for illustration only. Other embodiments of the method 5000 performed by a relay STA for multi-traffic: P2P between the relay STA and the destination STA could be used without departing from the scope of this disclosure.

As illustrated in FIG. 50, the method 5000 begins at step 5002, where the relay STA transmits a QoS request frame to the AP reporting the need for multi-traffic (P2P). At step 5004, the relay STA receives a QoS response frame from the AP. At step 5006, a determination is made whether the relay stay receives an acceptance. If the relay stay does not receive an acceptance, then at step 5008, the relay stay receives a rejected frame, and may perform as a legacy relay role. If the relay stay does receive an acceptance, then at step 5010, the relay stay receives a relaying frame from the AP. At step 5012, the relay STA relay replies with an ACK. At step 5014, the relay STA receives a TXOP sharing frame from the AP to become a TXOP holder for a second hop relay transmission. At step 5016, the relay STA replies with CTS. At step 5018, the relay STA transmits the multiplexing PPDUs including the relaying frame originated from the AP and the P2P traffic intended for the destination STA. At step 5020, the relay STA receives an ACK from destination STA. At step 5022, the relay STA transmits an ACK to the AP.

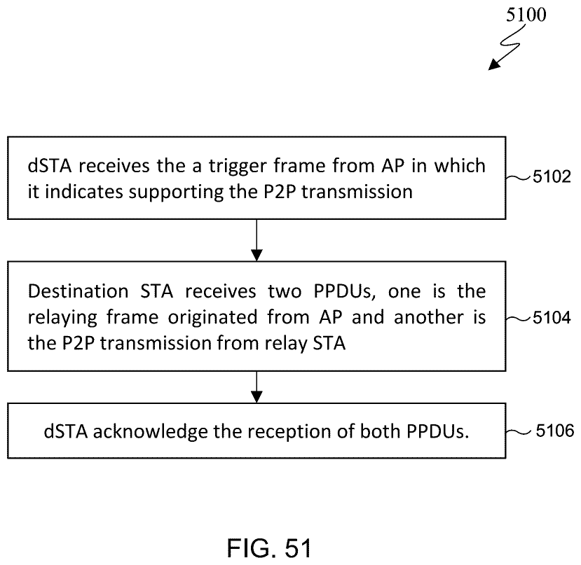

FIG. 51 illustrates an example flow diagram of a method 5100 performed by a destination STA for multi-traffic: P2P between the relay STA and the destination STA according to embodiments of the present disclosure. The embodiment of the method 5100 performed by a destination STA for multi-traffic: P2P between the relay STA and the destination STA shown in FIG. 51 is for illustration only. Other embodiments of the method 5100 performed by a destination STA for multi-traffic: P2P between the relay STA and the destination STA could be used without departing from the scope of this disclosure.

As illustrated in FIG. 51, the method 5100 begins at step 5102, where the destination STA receives a trigger frame from the AP in which it indicates supporting the P2P transmission from the AP. At step 5104, the destination STA receives two PPDUs, one is the relaying frame originated from the AP and another is the P2P transmission from the relay STA. At step 5106, the destination ST acknowledge the reception of both PPDUs.

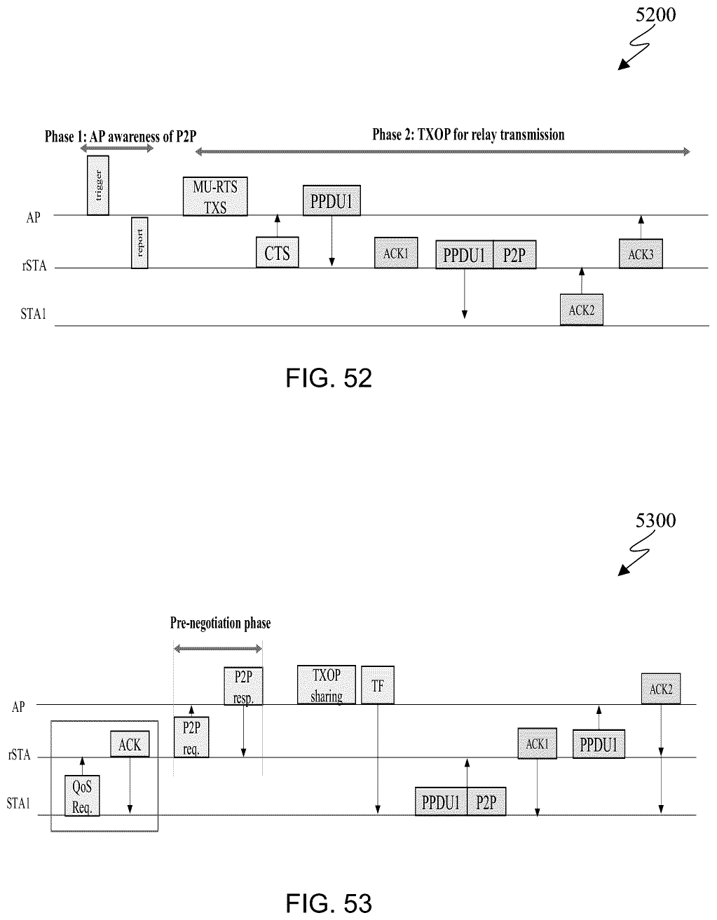

FIG. 52 illustrates an example of TXOP sharing for relay transmission with multi-traffic: DL P2P with triggered negotiation 5200 according to embodiments of the present disclosure. The embodiment of the example of TXOP sharing for relay transmission with multi-traffic: DL P2P with triggered negotiation 5200 shown in FIG. 52 is for illustration only. Other embodiments of the example of TXOP sharing for relay transmission with multi-traffic: DL P2P with triggered negotiation 5200 could be used without departing from the scope of this disclosure.

According to another embodiment, the element in one trigger frame can also be performed before the relay transmission. For example, the AP may transmit the BSRP trigger frame to pull the buffer status report from the relay before scheduling any TXOP sharing. In the buffer of the relay, it may need to indicate the purpose of the PPDU. An example is shown in FIG. 52.

FIG. 53 illustrates an example of TXOP sharing for relay transmission with multi-traffic: UL P2P 5300 according to embodiments of the present disclosure. The embodiment of the example of TXOP sharing for relay transmission with multi-traffic: UL P2P 5300 shown in FIG. 53 is for illustration only. Other embodiments of the example of TXOP sharing for relay transmission with multi-traffic: UL P2P 5300 could be used without departing from the scope of this disclosure.

According to one embodiment, the UL traffic can use the combination procedures described herein, an example is shown in FIG. 53. The pre-negotiation phase may happen before the relay transmission with multi-traffic.

The P2P transmission happens between the relay STA and STA1. The relay STA may be a group owner, soft-AP, master STA, representative STA, etc., so that it can be notified by the STA1 about the coming UL P2P traffic. An example of the transmission in shown in FIG. 53. STA1 may indicate the need for multi-traffic, i.e., both the relaying-frame for the AP, and a P2P transmission for the relay STA. The relay STA will notify the AP about the request.

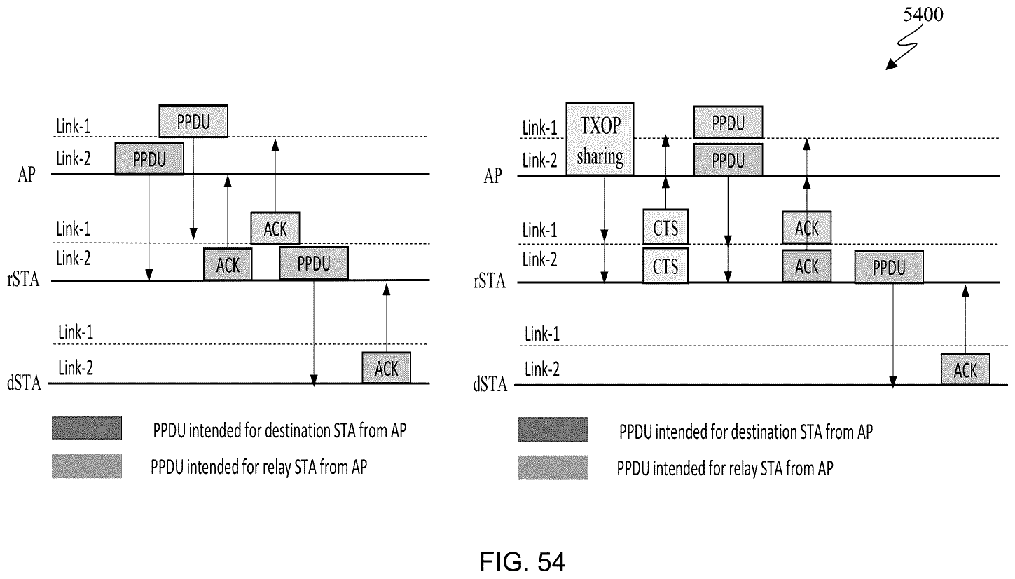

FIG. 54 illustrates an example of multi-traffic in multi-link operation (MLO) 5400 according to embodiments of the present disclosure. The embodiment of the example of multi-traffic in multi-link operation (MLO) 5400 shown in FIG. 54 is for illustration only. Other embodiments of the example of multi-traffic in multi-link operation (MLO) 5400 could be used without departing from the scope of this disclosure.

According to another embodiment, the multi-traffic may happen in different bands or links. If the STAs are operating on STR mode, it may perform the traffic in each link. For example, in the left figure of FIG. 54, the infra DL PDDU for the relay STA may be performed independently with relay transmission. If the STAs are operating on NSTR mode, it may indicate in the Resource Type of the multi-traffic element. The AP MLD may schedule the multi-traffic and relay traffic in different links with aligned starting time. After finishing the traffic on link-1, the STA can either perform the other transmission in STR or enter the doze state in NSTR mode.

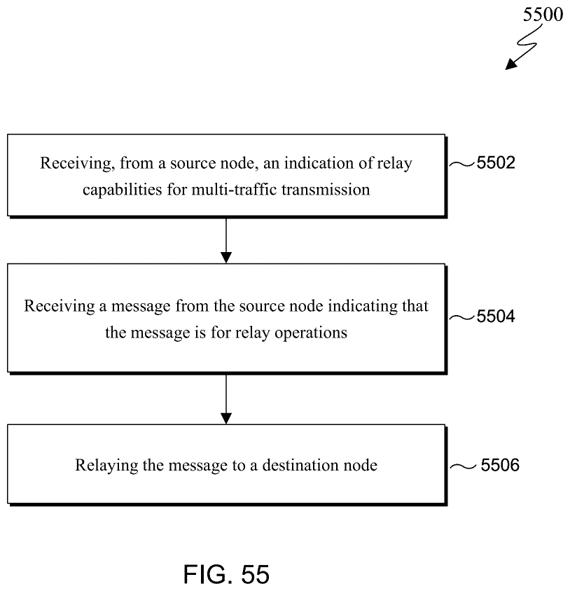

FIG. 55 illustrates a flow diagram of a method 5500 for wireless communication performed by a wireless device according to embodiments of the present disclosure. The example method 5500 shown in FIG. 55 is for illustration only. Other embodiments of the example method 5500 could be used without departing from the scope of this disclosure.

As illustrated in FIG. 55, the method 5500 begins at step 5502, where the wireless device receives, from a source node, an indication of relay capabilities for multi-traffic transmission. At step 5504; the wireless device receives a message from the source node indicating that the message is for relay operations. At step 5506, the wireless device relays the message to a destination node.

In one embodiment, the message comprises a first message and a second message, the first message including information intended for the wireless device and the second message including an indication that the second message is for relay operations, the wireless device accesses the first message including the information intended for the wireless device; and based on the indication that the second message is for relay operations, relays the second message to the destination node.

In one embodiment, to access the first message including the information intended for the wireless device, the wireless device uses A-MSDU encapsulation.

In one embodiment, to access the first message including the information intended for the wireless device, the wireless device uses A-MPDU encapsulation.

In one embodiment, to relay the message to the destination node, the wireless device uses a decode-and-forward relaying operation or an amplify-and-forward relaying operation.

In one embodiment, to relay the message to the destination node, the wireless device transmits the message to the destination node in a TXOP shared with the source node.

In one embodiment, when the destination node is out of range of a coverage area of the source node, to relay the message to the destination node, the wireless device relays a trigger frame for an uplink transmission to the destination node.

In one embodiment, the wireless device negotiates a TXOP sharing with the source node for multi-traffic multiplexing; and notifies the source node about relay transmission with multi-traffic.

The above flowcharts illustrate example methods that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a wireless device, the method comprising:
receiving, from a source node, an indication of relay capabilities for multi-traffic transmission;
receiving a message from the source node indicating that the message is for relay operations; and
relaying the message to a destination node.

2. The method of claim 1, wherein the message comprises a first message and a second message, the first message including information intended for the wireless device and the second message including an indication that the second message is for relay operations, the method further comprising:
accessing the first message including the information intended for the wireless device; and
based on the indication that the second message is for relay operations, relaying the second message to the destination node.

3. The method of claim 2, wherein accessing the first message including the information intended for the wireless device comprises using aggregate medium access control (MAC) service data unit (A-MSDU) encapsulation.

4. The method of claim 2, wherein accessing the first message including the information intended for the wireless device comprises using aggregate medium access control (MAC) protocol data unit (A-MPDU) encapsulation.

5. The method of claim 1, wherein relaying the message to the destination node comprises using a decode-and-forward relaying operation or an amplify-and-forward relaying operation.

6. The method of claim 1, wherein relaying the message to the destination node comprises transmitting the message to the destination node in a transmit opportunity (TXOP) shared with the source node.

7. The method of claim 1, wherein, when the destination node is out of range of a coverage area of the source node, relaying the message to the destination node comprises relaying a trigger frame for an uplink transmission to the destination node.

8. The method of claim 1, further comprising negotiating a transmit opportunity (TXOP) sharing with the source node for multi-traffic multiplexing, wherein negotiating the TXOP sharing further comprises notifying the source node about relay transmission with multi-traffic.

9. A wireless device comprising:
a transceiver; and
a processor operably coupled to the transceiver, the processor configured to:
receive, from a source node, an indication of relay capabilities for multi-traffic transmission;
receive a message from the source node indicating that the message is for relay operations; and
relay the message to a destination node.

10. The wireless device of claim 9, wherein the message comprises a first message and a second message, the first message including information intended for the wireless device and the second message including an indication that the second message is for relay operations, the processor further configured to:
access the first message including the information intended for the wireless device; and
based on the indication that the second message is for relay operations, relay the second message to the destination node.

11. The wireless device of claim 10, wherein to access the first message including the information intended for the wireless device, the processor is further configured to use aggregate medium access control (MAC) service data unit (A-MSDU) encapsulation.

12. The wireless device of claim 10, to access the first message including the information intended for the wireless device, the processor is further configured to use aggregate medium access control (MAC) protocol data unit (A-MPDU) encapsulation.

13. The wireless device of claim 9, wherein to relay the message to the destination node, the processor is further configured to use a decode-and-forward relaying operation or an amplify-and-forward relaying operation.

14. The wireless device of claim 9, wherein to relay the message to the destination node, the processor is further configured to transmit the message to the destination node in a transmit opportunity (TXOP) shared with the source node.

15. The wireless device of claim 9, wherein, when the destination node is out of range of a coverage area of the source node, to relay the message to the destination node, the processor is further configured to relay a trigger frame for an uplink transmission to the destination node.

16. The wireless device of claim 9, wherein the processor is further configured to:
negotiate a transmit opportunity (TXOP) sharing with the source node for multi-traffic multiplexing; and
notify the source node about relay transmission with multi-traffic.

17. A source node comprising:
a transceiver; and
a processor operably coupled to the transceiver, the processor configured to:
send an indication of relay capabilities for multi-traffic transmission to a wireless device; and
send a message to the wireless device indicating that the message is for relay operations.

18. The source node of claim 17, wherein the message comprises a first message and a second message, the first message including information intended for the wireless device and the second message including information intended for a destination node.

19. The source node of claim 17, wherein the processor is further configured to negotiate a transmit opportunity (TXOP) sharing with the source node for multi-traffic multiplexing.

20. The source node of claim 19, wherein to negotiate the TXOP sharing, the processor is further configured to receive a notification from the wireless device about relay transmission with multi-traffic.
